(19) United States
(12) Patent Application Publication
(10) Pub. No.: US 2010/0287092 A1
(43) Pub. Date: Nov. 11, 2010

(54) Method and system for real estate loan administration

(75) Inventors: Connie June Colman, Phoenix, AZ (US); Gary William Spore, Mesa, AZ (US); John Roberts Kuberra, Paradise Valley, AZ (US)

Correspondence Address: HUNTON & WILLIAMS LLP;INTELLECTUAL PROPERTY DEPARTMENT, 1900 K STREET, N.W., SUITE 1200, WASHINGTON, DC, 20006-1109, US

(73) Assignee: Bank One, Delaware National Association

(21) Appl. No.: 10/784,968

(22) Filed: Feb. 25, 2004

(51) Int. Cl. G06Q 40/00

(52) U.S. Cl. 705/38

(57) ABSTRACT

An embodiment of the present invention relates to real estate loan administration comprising the steps of registering with a system for real estate loan administration wherein at least one loan is identified; identifying one or more participants associated with the at least one loan to join the system for real estate loan administration; assigning one or more of privileges and roles to each of the one or more participants; managing the at least one loan via the system through an online interface wherein data associated with the at least one loan may be accessed and viewed according to user input; and performing one or more actions concerning the at least one loan wherein the one or more actions involve submitting information to a receiving entity.

### FIELD OF THE INVENTION

The present invention relates generally to real estate loan administration, and more specifically to providing an online web interface for real estate loan administration.

### BACKGROUND OF THE INVENTION

Generally, almost every construction project requires some type of loan. Construction projects may involve new constructions sites, including commercial and private, as well as renovations and additions to existing structures. Construction in various forms may be initiated by a private company, government entity, non-profit group, individual owner (including family unit) and essentially any other entity able to qualify for a loan. For residential areas, construction projects may involve a single unit (e.g., detached house, townhouse, condominium, rental units, etc.), multiple units, as well as entire neighborhoods and other development areas. Commercial construction projects may include stores, restaurants, malls, gas stations, and other commercial establishments. As such projects require large amounts of finances oftentimes in the hundreds of thousands to multi-million dollar projects, a loan or multiple loans are often required.

Loans are generally provided by a lender, such as a bank or other financial institution. Current systems of applying for loans require information to be processed manually by paper. The paperwork and other information to be processed can be onerous and complicated. In another example, customer information may be processed through a software, such as a spreadsheet program selected by the customer. Once that information is processed, the information may be submitted to the lender, e.g., a bank or other financial institution. At the lender establishment, the information is generally re-processed (or re-entered) into a system specific to that lender. If multiple loans are applied for at different establishments, each lender may require a different system for processing information. As a result, various inefficiencies occur thereby leading to higher costs and longer delays for customers and other participants involved in the construction project.

As various updates and other developments may occur, the information submitted initially may need to be updated or otherwise modified. However, current systems fail to provide an easy-to-use, efficient medium for communicating information and updating previously submitted information. In addition, each action associated with the loan (e.g., draws, update in collateral, etc.) will generally require various paperwork and a time-consuming approval process.

Other drawbacks may also be present.

### SUMMARY OF THE INVENTION

Accordingly, one aspect of the invention is to address one or more of the drawbacks set forth above.

In one exemplary embodiment of the present invention, a computer implemented method for real estate loan administration comprises the steps of registering with a system for real estate loan administration wherein at least one loan is identified; identifying one or more participants associated with the at least one loan to join the system for real estate loan administration; assigning one or more of privileges and roles to each of the one or more participants; managing the at least one loan via the system through an online interface wherein data associated with the at least one loan may be accessed and viewed according to user input; and performing one or more actions concerning the at least one loan wherein the one or more actions involve submitting information to a receiving entity.

In accordance with other aspects of this exemplary embodiment of the present invention, the step of managing further comprises the step of accessing loan data specific for the at least one loan wherein loan data comprises one or more of insurance data, interest data and budget summary data; the step of managing further comprises the step of accessing collateral data associated with the at least one loan; wherein the one or more actions comprise submitting one or more draw requests; wherein the one or more draw requests comprises line item draw requests; wherein the one or more draw requests comprises unit draw requests for one or more of new starts and existing units; wherein the step of registering with the system further comprises the steps of identifying one or more of insurance, interest, budget, collateral and contact information associated with each loan; requesting one or more reports to be generated for the at least one loan based on one or more user defined specifics; wherein the step of performing one or more actions comprises the step of adding collateral data for at least one new collateral associated with the loan; wherein the step of performing one or more actions comprises the step of updating collateral data for at least one collateral associated with the loan; wherein collateral data comprises one or more of plan type, status, sales price, amount complete and remote cost data; analyzing the collateral data to determine collateral eligibility; generating a compliance worksheet for identifying one or more compliance issues associated with the at least one loan; updating data associated with the at least one loan and importing the updated data to a receiving entity; wherein the data comprises collateral data concerning one or more pieces of collateral associated with the at least one loan and wherein the receiving entity is a lender entity and the collateral data comprises one or more of plan type, status, sales price, amount complete and remote cost data; updating data associated with the at least one loan, specifying one or more filters to be applied to the updated data and exporting the filtered updated data from the system for real estate loan administration to a remote device; wherein the data comprises collateral data comprising one or more of plan type, status, sales price, amount complete and remote cost data; wherein the remote device comprises one or more of personal computer, personal digital assistant and wireless device; specifying one or more triggering events associated with the at least one loan, specifying one or more contacts to be notified at an occurrence of the one or more triggering events and specifying one or more preferred modes of notification for the one or more contacts at the occurrence of the one or more triggering events; authorizing one or more participants for collaboration and assigning one or more of roles and privileges for collaboration to each participant; wherein one or more documents may be shared simultaneously with the authorized one or more participants via a common online interface; and wherein the receiving entity is a lender entity.

In accordance with another exemplary embodiment of the present invention, a computer implemented system for real estate loan administration comprises registration module for registering with a system for real estate loan administration wherein at least one loan is identified; invitation module for identifying one or more participants associated with the at least one loan to join the system for real estate loan administration; and assigning one or more of privileges and roles to each of the one or more participants; and loan module for managing the at least one loan via the system through an online interface wherein data associated with the at least one loan may be accessed and viewed according to user input; and performing one or more actions concerning the at least one loan wherein the one or more actions involve submitting information to a receiving entity.

In accordance with another exemplary embodiment of the present invention, a computer implemented method for providing real estate loan administration comprises the steps of enabling a user to register with a system for real estate loan administration wherein at least one loan is identified by the user and the user is assigned a user identifier and a password; sending a message to one or more participants associated with the at least one loan to join the system for real estate loan administration wherein the one or more participants are identified by the user; applying one or more of privileges and roles to each of the one or more participants wherein the one or more privileges and roles are assigned by the user; processing data associated with the at least one loan via the system through an online interface; and performing one or more actions concerning the at least one loan wherein the one or more actions involve submitting information to a receiving entity.

In accordance with another exemplary embodiment of the present invention, a computer implemented system for providing real estate loan administration comprises registration module for enabling a user to register with a system for real estate loan administration wherein at least one loan is identified by the user and the user is assigned a user identifier and a password; invitation module for sending a message to one or more participants associated with the at least one loan to join the system for real estate loan administration wherein the one or more participants are identified by the user and applying one or more of privileges and roles to each of the one or more participants wherein the one or more privileges and roles are assigned by the user; and loan module for processing data associated with the at least one loan via the system through an online interface; and performing one or more actions concerning the at least one loan wherein the one or more actions involve submitting information to a receiving entity.

In accordance with another exemplary embodiment of the present invention, at least one signal embodied in at least one carrier wave for transmitting a computer program of instructions configured to be readable by at least one processor to execute a computer process for real estate loan administration, the computer process comprises registering means for registering with a system for real estate loan administration wherein at least one loan is identified; identifying means for identifying one or more participants associated with the at least one loan to join the system for real estate loan administration; assigning means for assigning one or more of privileges and roles to each of the one or more participants; managing means for managing the at least one loan via the system through an online interface wherein data associated with the at least one loan may be accessed and viewed according to user input; and performing means for performing one or more actions concerning the at least one loan wherein the one or more actions involve submitting information to a receiving entity.

In accordance with another exemplary embodiment of the present invention, at least one signal embodied in at least one carrier wave for transmitting a computer program of instructions configured to be readable by at least one processor to execute a computer process for real estate loan administration, the computer process comprises enabling means for enabling a user to register with a system for real estate loan administration wherein at least one loan is identified by the user and the user is assigned a user identifier and a password; sending means for sending a message to one or more participants associated with the at least one loan to join the system for real estate loan administration wherein the one or more participants are identified by the user; applying means for applying one or more of privileges and roles to each of the one or more participants wherein the one or more privileges and roles are assigned by the user; processing means for processing data associated with the at least one loan via the system through an online interface; and performing means for performing one or more actions concerning the at least one loan wherein the one or more actions involve submitting information to a receiving entity.

In accordance with another exemplary embodiment of the present invention, an article of manufacture for real estate loan administration comprising at least one processor readable carrier; and instructions carried on the at least one carrier; wherein the instructions are configured to be readable from the at least one carrier by at least one processor and thereby cause the at least one processor to operate so as to: register with a system for real estate loan administration wherein at least one loan is identified; identify one or more participants associated with the at least one loan to join the system for real estate loan administration; assign one or more of privileges and roles to each of the one or more participants; manage the at least one loan via the system through an online interface wherein data associated with the at least one loan may be accessed and viewed according to user input; and perform one or more actions concerning the at least one loan wherein the one or more actions involve submitting information to a receiving entity.

In accordance with another exemplary embodiment of the present invention, an article of manufacture for real estate loan administration comprising: at least one processor readable carrier; and instructions carried on the at least one carrier; wherein the instructions are configured to be readable from the at least one carrier by at least one processor and thereby cause the at least one processor to operate so as to: enable a user to register with a system for real estate loan administration wherein at least one loan is identified by the user and the user is assigned a user identifier and a password; send a message to one or more participants associated with the at least one loan to join the system for real estate loan administration wherein the one or more participants are identified by the user; apply one or more of privileges and roles to each of the one or more participants wherein the one or more privileges and roles are assigned by the user; process data associated with the at least one loan via the system through an online interface; and perform one or more actions concerning the at least one loan wherein the one or more actions involve submitting information to a receiving entity.

### BRIEF DESCRIPTION OF THE DRAWINGS

FIG. 1 is a schematic representation of a system for real estate loan administration, according to an embodiment of the present invention.

FIG. 2 is an exemplary interface for providing account summary information, according to an embodiment of the present invention.

FIG. 3 is an exemplary interface for providing loan summary information, according to an embodiment of the present invention.

FIG. 4 is an exemplary interface for providing insurance information, according to an embodiment of the present invention.

FIG. 5A is an exemplary interface for providing interest information, according to an embodiment of the present invention.

FIG. 5B is an exemplary interface for providing interest information, according to an embodiment of the present invention.

FIG. 6 is an exemplary interface for providing budget summary information, according to an embodiment of the present invention.

FIG. 7 is an exemplary interface for providing collateral summary information, according to an embodiment of the present invention.

FIG. 8 is an exemplary interface for providing lots information, according to an embodiment of the present invention.

FIG. 9 is an exemplary interface for providing contact information, according to an embodiment of the present invention.

FIG. 10 is an exemplary interface for requesting a line item draw request, according to an embodiment of the present invention.

FIG. 11 is an exemplary interface for editing a line item draw, according to an embodiment of the present invention.

FIG. 12 is an exemplary interface for a unit draw request, according to an embodiment of the present invention.

FIG. 13 is an exemplary interface for a new starts draw request, according to an embodiment of the present invention.

FIG. 14 is an exemplary interface for editing a new start unit, according to an embodiment of the present invention.

FIG. 15 is an exemplary interface for an existing units draw request, according to an embodiment of the present invention.

FIG. 16 is an exemplary illustration of a collateral module, according to an embodiment of the present invention.

FIG. 17 is an exemplary illustration of a collateral page, according to an embodiment of the present invention.

FIG. 18 is an exemplary illustration of a Base View, according to an embodiment of the present invention.

FIG. 19 is an exemplary illustration of a Subdivision View, according to an embodiment of the present invention.

FIG. 20 is an exemplary illustration of a Plan View, according to an embodiment of the present invention.

FIG. 21 is an exemplary illustration of a Unit View, according to an embodiment of the present invention.

FIG. 22 is an exemplary illustration of a Collateral Update View, according to an embodiment of the present invention.

FIG. 23 is an exemplary flowchart illustrating a method for loan administration, according to an embodiment of the present invention.

FIG. 24 is an exemplary flow diagram illustrating a draw request process, according to an embodiment of the present invention.

FIG. 25 is an exemplary flowchart illustrating a method for loan administration, according to an embodiment of the present invention.

### DETAILED DESCRIPTION OF THE INVENTION

A system and process for improving efficiency of managing loans in the real estate industry is described. According to one exemplary aspect, the system and process is directed to real estate loan administration. One technical effect of the invention is to provide a system and process for providing an online web interface for real estate loan administration, as set forth in the Brief Description of the Invention, above and as more fully described here in the Detailed Description of the Invention. Various aspects and components of this system and process are described below. While the present invention is described in terms of real estate loans (e.g., construction loans, commercial loans, etc.) in particular, it is recognized that the embodiments of the present inventions may apply to other types of loans as well.

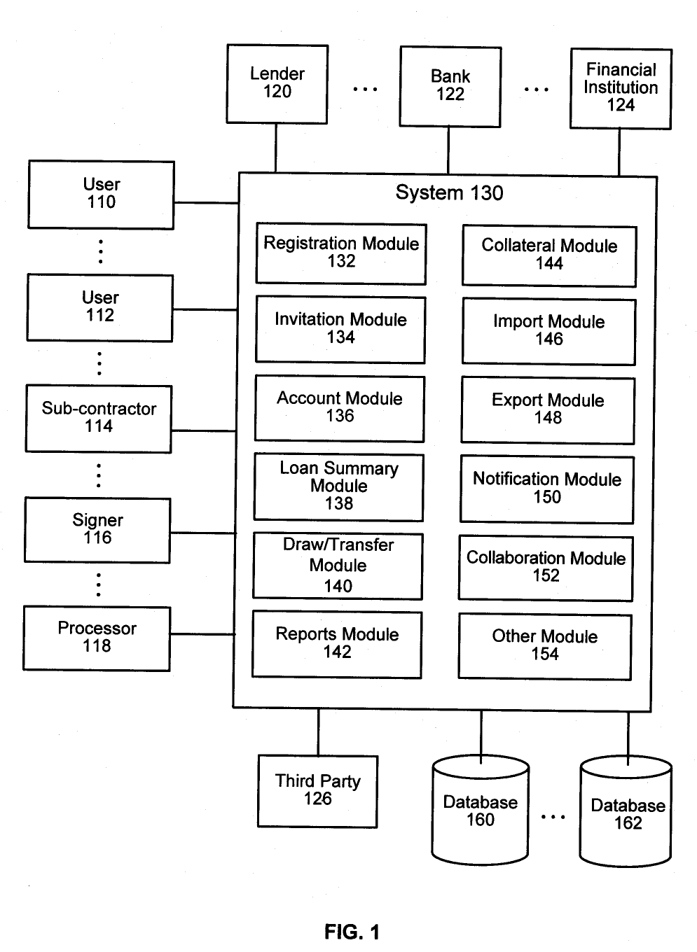

FIG. 1 is a schematic representation of a system for real estate loan administration, according to an embodiment of the present invention. System 130 enables a user to access, compile, manipulate, and otherwise interact with information regarding one or more loans for various projects. Various users may access System 130 to perform functions associated with loan administration via a communication network, such as Internet, Intranet, Ethernet and other types of networks. For example, users 110, 112 may include a customer, borrower, an entity, inspection consultant and/or other user of the system, including loan lending entities and/or other participants. An entity may include a contractor (or sub-contractor, other affiliate, etc.), commercial developer, a private company, government entity, non-profit organization or other borrowing entity. Loan lending entities may include Lender 120, Bank 122, Financial Institution 124 and other lending entities, such as saving and loan associations, credit unions, brokers, finance companies, etc. Other participants may include subcontractor 114, signer 116, processor 118, third party 126 and other participants of a loan or project, such as suppliers, laborers, etc. Additional participants may be included based on various applications.

System 130 may include modules and functions associated with loan administration. System 130 may include Registration Module 132, Invitation Module 134, Account Module 136, Loan Summary Module 138, Draw/Transfer Module 140, Reports Module 142, Collateral Module 144, Import Module 146, Export Module 148, Notification Module 150, Collaboration Module 152 and other module 154. The modules may function separately or in various combinations. While the modules are shown within a single system, the modules may also operate among several systems. Additional functions associated with loan administration may be provided through other modules.

The modules may communicate with a plurality of databases, which may also function collectively or separately. The modules of System 130 may access, retrieve, store and otherwise manipulate various information stored in databases 160, 162. In addition, the modules may access other information from external sources and/or other sources of information. Databases 160, 162 may store and organize data associated with various loans, projects, users, etc. Databases 160, 162 may represent various sources of data, which may be located at a common site, which may be local or remote, distributed among several locations, or maintained at other locations and according to different database structures. The data may be inputted by the user at registration, imported electronically, or otherwise received from a source.

An embodiment of the present invention provides access to real-time construction loan account information, detailed views in varying levels of loan data, collateral data and/or other information; ability to grant access to other individuals (or participants) in the user's company (or other association), ability to invite other participants to join the system and view data associated with an account as well as perform other functions and administrative services.

For example, the system of an embodiment of the present invention may manage constructions loans. Construction loans generally refer to a short-term, interim loan used to pay for building where the lender pays out the money in stages, called draws, as work progresses. Construction loans are usually variable-rate loans priced at a short term interest rate, for example, where a draw schedule may be established based on stages of construction and interest is charged on the amount of money disbursed. Other types of loans may be managed by the various embodiments of the present inventions.

Registration Module 132 provides a registration process for a participating entity. For example, a user 110 (e.g., borrowing entity, etc.) may be provided with a user identifier and a password (or PIN). The user identifier may be selected by the user or provided by the system. The user identifier may include an email address, a combination of the user's first and last name or any other identifier which may include letters, numbers and/or any combination thereof. In addition, a random user identifier may be provided by the system. The password may be selected by the user or provided by the system and may include letters, numbers and/or any combination thereof. The user identifier and password may authenticate the user and provide the user with access to information regarding loans and/or projects associated with the user. The user may also have access to other information outside of the user's loans and/or projects based on certain roles and/or privileges. For example, the user may have restricted access to certain data (e.g., view only ability to certain documents/data, etc.). Registration information may include personal identification information, such as name, company name, job title, address, contact information (e.g., phone number, pager, cellular phone, etc.), fax, email address and/or other information.

In addition, the user may view customer general information where the customer may include a borrowing entity, a third party client or other entity, including other participants who may or may not be associated with the user. This view may display customer number, customer name, and/or other additional information associated with each customer (or other participant). Customer information may be updated and/or modified (e.g., add information, rename, change information, etc.). Customer information may include company name, contact information (e.g., phone number, fax, cellular number, pager, email, etc.), mailing address, billing address, reason for change, etc.

Each user of the system may invite various other participants to the system. For example, the user may invite sub-contractors, bankers, processors, customers, inspectors, member banks and/or other participants.

Invitation Module 134 enables the user to invite other participants to the system. Through a new participant request, the user may authorize the system to send an invitation. For example, the system may send an email invitation or other message via various forms of communication (e.g., pager, phone, wireless communication, fax, etc.). The user may invite the participant to join a specific project and/or loan. For example, each new participant may be assigned to customer(s) (or user(s)), project(s) and/or loan(s). The user may also assign a role to each new participant. For example, the user may provide signer authority, processor authority, other authorities or no assignment. Other types of authorities may be provided based on different roles. Signer authority may involve ability to enter and submit draw requests to a financial institution (e.g., bank, lender, etc.). Processor authority may involve ability to enter draw requests and submit the draw requests to a participant with signer authority. According to another example, processor authority may provide the ability to submit requests to a financial institution where the financial institution may follow-up with confirmation, which may include paperwork or other additional actions. In addition, the user may assign privileges and/or specify access authority to each participant or group of participants. For example, access to documents, ability to view data as well as ability to take certain actions may be assigned on an individual basis. In addition, a user-defined role may be assigned to a participant for individualized access and/or privileges.

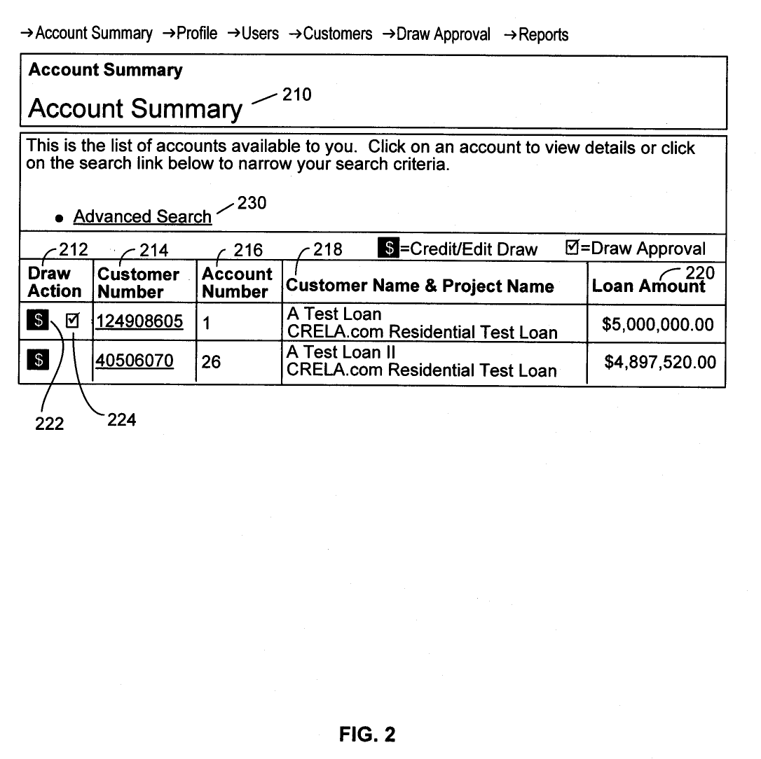

Account Module 136 may provide account information, such as an account summary view. For example, a list of accounts available to each user may be displayed. FIG. 2 is an exemplary interface for providing account summary information, according to an embodiment of the present invention. Account summary 210 for loans associated with a user may include draw action 212, customer number 214, account number 216, customer name & project name 218, and loan amount 220. Draw action may include creating/editing draw 222 and draw approval 224. For example, if a request is prepared by a Processor (e.g., a person not authorized by a company to request funds), the Processor may enter the request into the system and submit the request to an authorized Signer (e.g., a person authorized by the company to request funds) who may then review, approve and submit the request to a receiving entity, such as a bank.

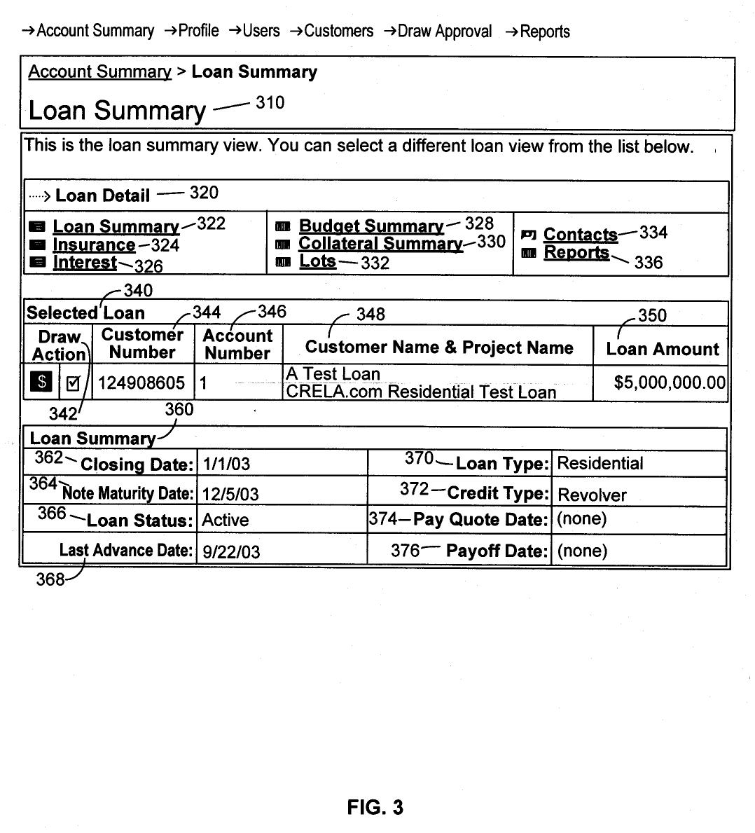

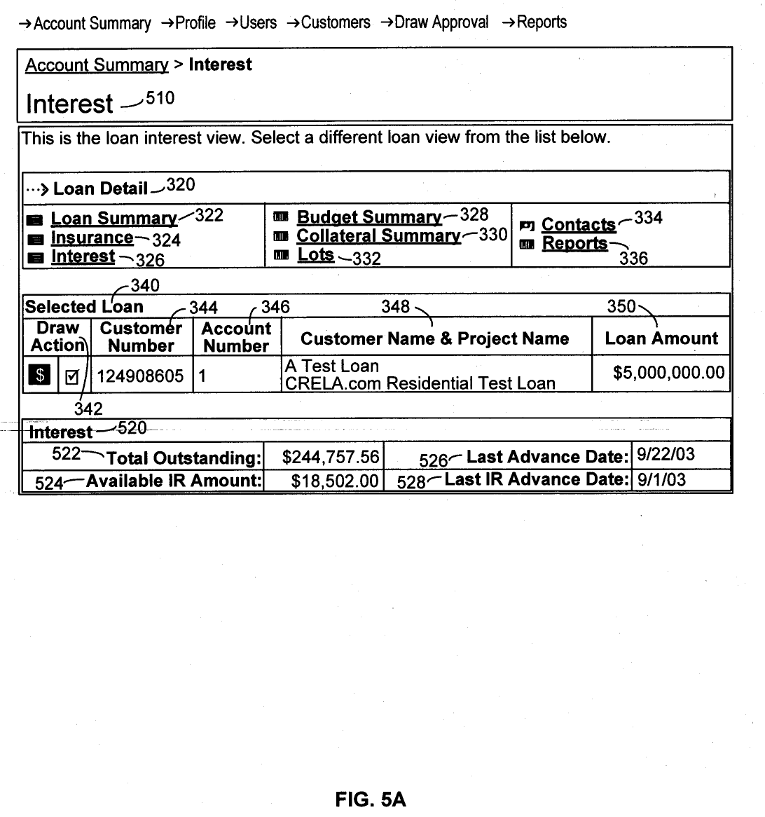

Loan Summary Module 138 may provide loan information for a specific loan. FIG. 3 is an exemplary interface for providing loan summary information, according to an embodiment of the present invention. Loan Summary 310 may provide a loan summary view where various different loan detail views may be selected. Loan Detail 320 may include loan summary 322, insurance 324, interest 326, budget summary 328, collateral summary 330, lots 332, contacts 334 and/or reports 336, as well as budget detail 338 (as shown in FIG. 5B below). Other information associated with loans may also be provided.

For a selected loan 340, account summary information may be provided, which may include draw action 342, customer number 344, account number 346, customer name & project name 348 (which may include residential, commercial and/or other projects), and loan amount 350. Additional information may also be provided.

Loan Summary 360 may display various characteristics of a selected loan. For example, Loan Summary 360 may include closing date 362, note maturity date 364, loan status 366 (e.g., active, new, guidance line, paid off, internal guidance facility, etc.), last advance date 368, loan type 370 (e.g., residential, commercial, acquisition and development, custom home, letter of credit, working capital, borrowing base, etc.), credit type 372 (e.g., revolving line of credit, non-revolving line of credit, etc.), pay quote date 374, and/or payoff date 376. Other loan summary information may include Base Drive (or other unique code which may be tied to database records for various facilities), Maximum Allowable Advance (MAA), collateral value, aggregate outstanding loan, and current available (e.g., an amount remaining to be disbursed based on budgets and/or other collateral values). Other data associated with the loan may be displayed.

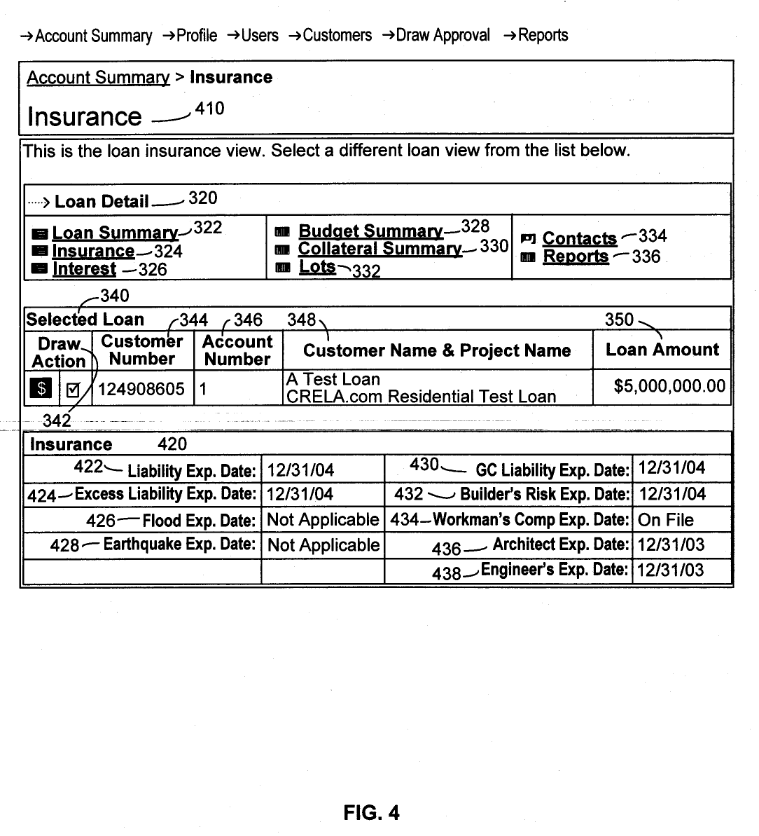

FIG. 4 is an exemplary interface for providing insurance information, according to an embodiment of the present invention. Depending on the type of project, loan and/or other considerations, various types of insurance may be applied. Based on the type of insurance available, various data pertinent to the specific insurance may be displayed. Insurance information may provide details (e.g., expiration dates, insurance type, policy numbers, etc.) concerning coverage in the event of loss during construction, renovation, remodeling and/or other activity. In the example of FIG. 4, insurance 420 may include liability expiration date 422, excess liability expiration date 424, flood expiration date 426, earthquake expiration date 428, General Contractor (GC) liability expiration date 430, builder's risk expiration date 432, workman's compensation expiration date 434, architect expiration date 436, and engineer's expiration date 438. Other data associated with insurance information may be displayed.

FIGS. 5A and 5B are exemplary interfaces for providing interest information, according to an embodiment of the present invention. Depending on the type of project, loan and/or other considerations, various types of interest may be applied. Based on the type of interest for the selected loan, various data pertinent to the specific interest may be displayed. Interest information may refer to money paid for a borrower's use of money calculated as a percentage of the money borrowed and paid over a specified time. In the example of FIG. 5A, interest 520 may include total outstanding interest amount 522, available Interest Reserve (IR) amount 524, last advance date 526, and last IR advance date 528.

In the example of FIG. 5B, Interest 540 may be displayed for an exemplary commercial loan, as identified in 348. Interest 550 may include total outstanding interest amount 552, available IR amount 554, total LIBOR Amount 556, last advance date 558, last IR advance date 560 and Total Prime Amount 562. Other interest information may include forms of aggregate commitment used, such as total fixed rate outstanding amount (e.g., sum of LDS LIBOR records), total variable rate outstanding amount (e.g., difference between total outstanding minus total fixed rate outstanding amount), letters of credit subtotal and other details (e.g., number, amount, effective date, maturity date), and adjustments (e.g., amount, description, based on active only (e.g., true status)). Sum of LDS LIBOR may include specific amounts locked into a “fixed” rate for a specified timeframe at which point no (or limited) changes to the rate and/or balance may be made (other restrictions may be applied). At maturity, the amount and/or rate may be changed usually within a certain time frame (e.g., 30, 60, 90 days, etc.) and/or based on approved loan documentation as well as other factors. Other data associated with interest information may be displayed.

According to another iteration of the present invention, LIBOR information may be provided to the user. As illustrated at LIBOR 570, note number (or other identifier) 572, amount 574, maturity date 576, next notice date 578, index rate 580, spread rate 582 and/or other information associated with LIBORs may be displayed. LIBOR stands for London Inter Bank Offer Rate, which is the rate of interest at which banks offer to lend money to one another in the wholesale money markets in London. It may be a standard financial index used in U.S. capital markets. In general, it is an index that may be used to set the cost of various variable-rate loans, including credit cards and adjustable-rate mortgages, for example. Such information may include note number, amount, maturity date, next notice date, index rate, spread rate, and all-in rate (e.g., sum of index rate and spread rate). Still other information may include advances and payments.

As shown in FIG. 5B, multiple LIBORs may be applied. Exemplary applications may involve multiple traunches for one facility and/or multiple traunches for multiple facilities, for example. Traunches may refer to part of an asset that is divided into smaller pieces. For example, traunches may refer to a mortgage-backed security where a first financial institution may have an interested in payments at the longer end of the security's maturity while a second financial institution may have an interested in cash flows that are due in the near term. The original asset may be divided into traunches where each party (e.g., the first financial institution and the second financial institution bank) may receive rights to the expected cash payment for particular periods. Additional financial institutions and/or participants may be involved.

According to another embodiment of the present inventions, LIBOR management may be achieved through notifications that may be created by the user, as discussed below in connection with Notification Module 150. For example, when a LIBOR is about to expire, a notification may be sent to an intended recipient at a predetermined time (e.g., 1 week prior to expiration, etc.) with a message requesting for instructions and/or actions. In addition, various automatic notifications may be programmed to be sent to a user and/or other intended recipients. For example, if a LIBOR is about to expire, a notification may be sent a day prior to expiration (or other time period) informing the recipient of an action (e.g., roll into a standard rate) if the LIBOR is not renewed. Other actions and notifications may be sent for efficient LIBOR management.

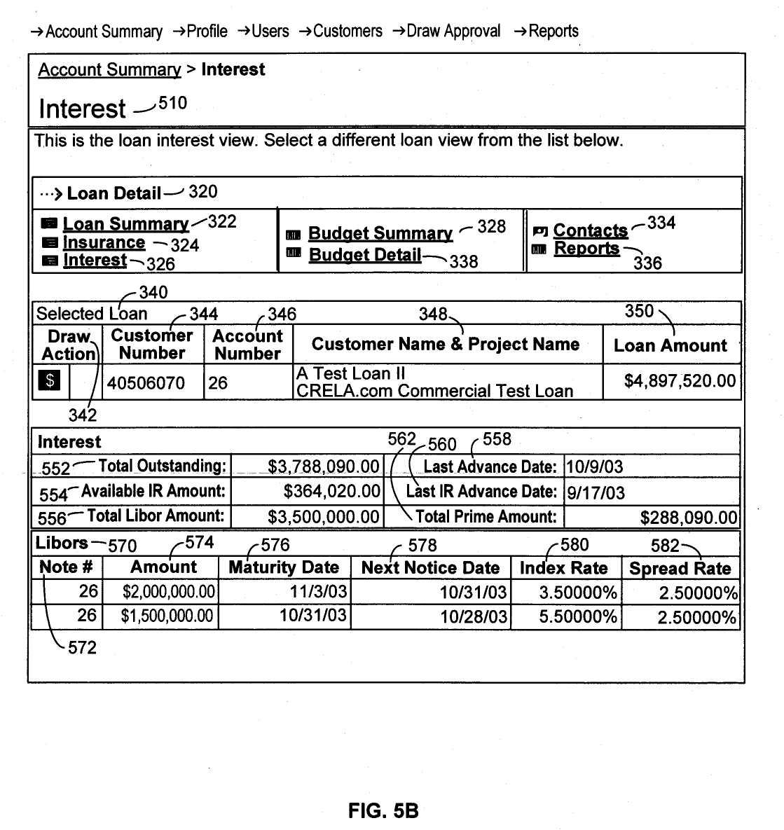

FIG. 6 is an exemplary interface for providing budget summary information, according to an embodiment of the present invention. Depending on the type of project, loan and/or other considerations, various types of budget summary information may be applied. Based on the type of budget summary for the selected loan, various data pertinent to the specific budget may be displayed. Budget summary information may include details concerning the cost of an entire loan and/or project. In the example of FIG. 6, budget summary 620 may include total project cost 622, note amount 624, total equity required 626, total equity disbursed 628, remaining equity 630, total disbursed 632, total payments 634, total outstanding 636, and total available 638. Other data associated with budget information may be displayed. For example, for non-residential loans (e.g., commercial loans, etc.), budget detail information may include line item (e.g., identifier), description (e.g., land, offsites, permits/fees, site work, contingency, architecture, soft costs, legal, bank fees, interest reserves, equity, equity, payment, etc.), revised budget, disbursed amount, percent disbursed, remaining amount, and/or other information associated with non-residential loan budgets.

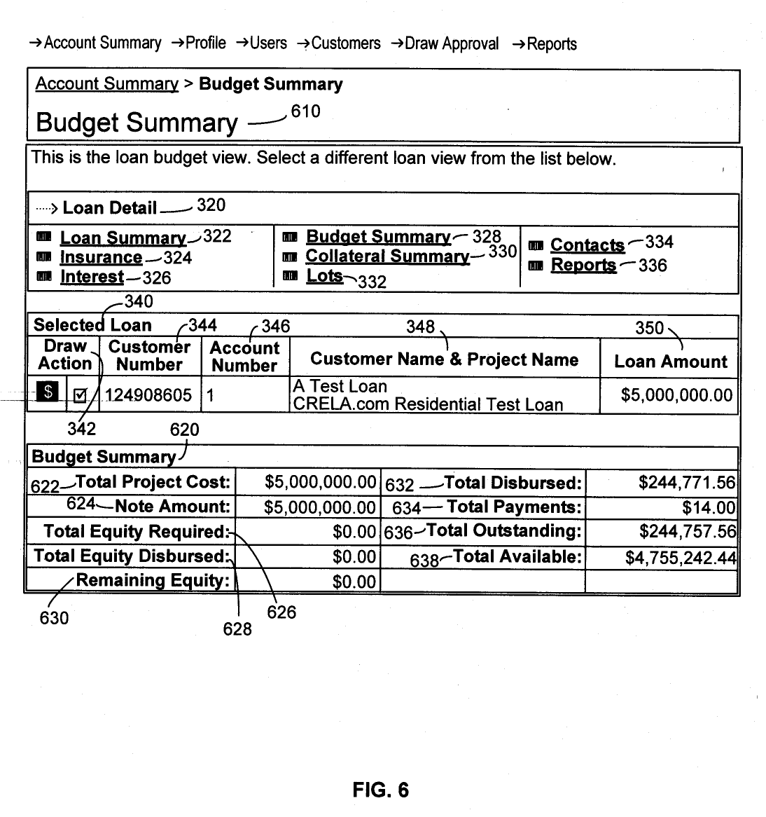

FIG. 7 is an exemplary interface for providing collateral summary information, according to an embodiment of the present invention. Depending on the type of project, loan and/or other considerations, various types of collateral summary information may be applied. Based on the type of collateral summary for the selected loan, various data pertinent to the specific collateral may be displayed. Collateral information may refer to details concerning property pledged as security to a loan where upon the borrower's inability to repay the loan, the lender may gain ownership of the collateral and sell it to recover the money. In the example of FIG. 7, collateral summary 720 may include total number of lots 722, total presolds (e.g., house or structure with a valid sales contract) 724, total specs (e.g., house or structure without a sales contract) 726, total models (e.g., house or structure used to display available homes and/or options within a subdivision) 728, total lot types 730, total undesignated 732, total lots remaining 734, total payoffs 736, maximum specs 738, maximum models 740, and maximum lot types 742. Other data associated with collateral information may be displayed.

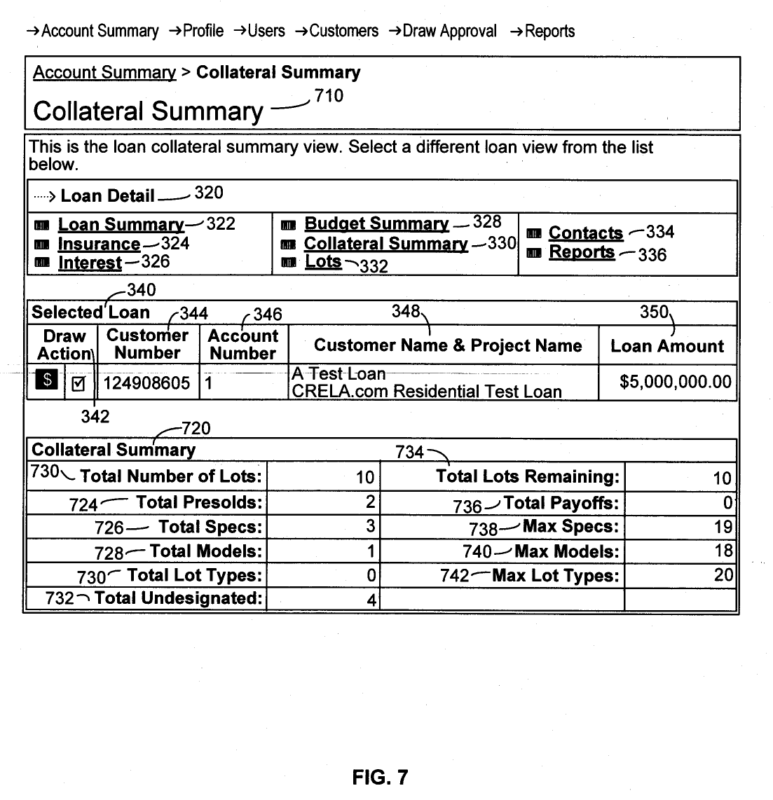

FIG. 8 is an exemplary interface for providing lots information, according to an embodiment of the present invention. Depending on the type of project, loan and/or other considerations, various types of lots information may be applied. Based on the type of lots for the selected loan, various data pertinent to the specific lots may be displayed. Lots may refer to a piece of real estate. In the example of FIG. 8, lots 820 may include sub code 822, lot number 824, block 826, status 828 (e.g., presold, specs, undesignated, model, lot, etc.), loan amount 830, disbursed amount 832, percent disbursed 834, and remaining amount 836. Block may refer to a designated value based on what the customer needs to further delineate collateral. In other applications, block may be referred to as phase, building, tract or other reference that may be unique to each facility. Other data associated with lots information may be displayed.

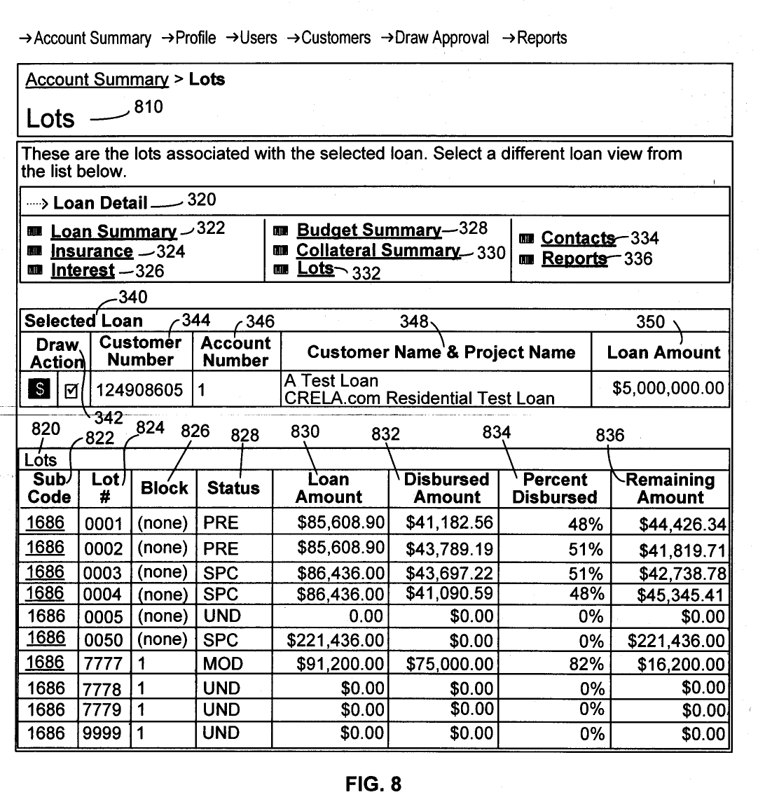

FIG. 9 is an exemplary interface for providing contact information, according to an embodiment of the present invention. Depending on the type of project, loan and/or other considerations, various types of contact information may be applied. Based on the type of contacts for the selected loan, various data pertinent to the specific contacts may be displayed. Contact 910 provides a list of participants and various forms of contact information for a specific loan (or project, company, etc.). In the example of FIG. 9, contacts 920 may include various contact information (e.g., phone number, email, pager, cellular phone, fax, etc.) for various types of contact, which may include risk administrator, disburser, banker, bank inspector, signers and processors. An email communication or other type of communication may be sent to an individual contact, a group of contacts (e.g., all signers) or all contacts associated with a loan or project. Other data associated with contact information may be displayed.

Draw/Transfer module 140 may enable a user (or authorized participant) to perform various actions, such as a draw, transfer or other actions associated with a loan. A draw may refer to a payment, which may be made periodically, to an entity (e.g., customer, construction contractor, subcontractor, etc.) as work progresses, as part of a construction loan. Draws may include line item draws, existing residential unit draws, new unit start draws and other types of draws. In addition, draw requests may include line item requests for commercial, acquisition and development, lines of credit, custom homes and working capital loans, for example.

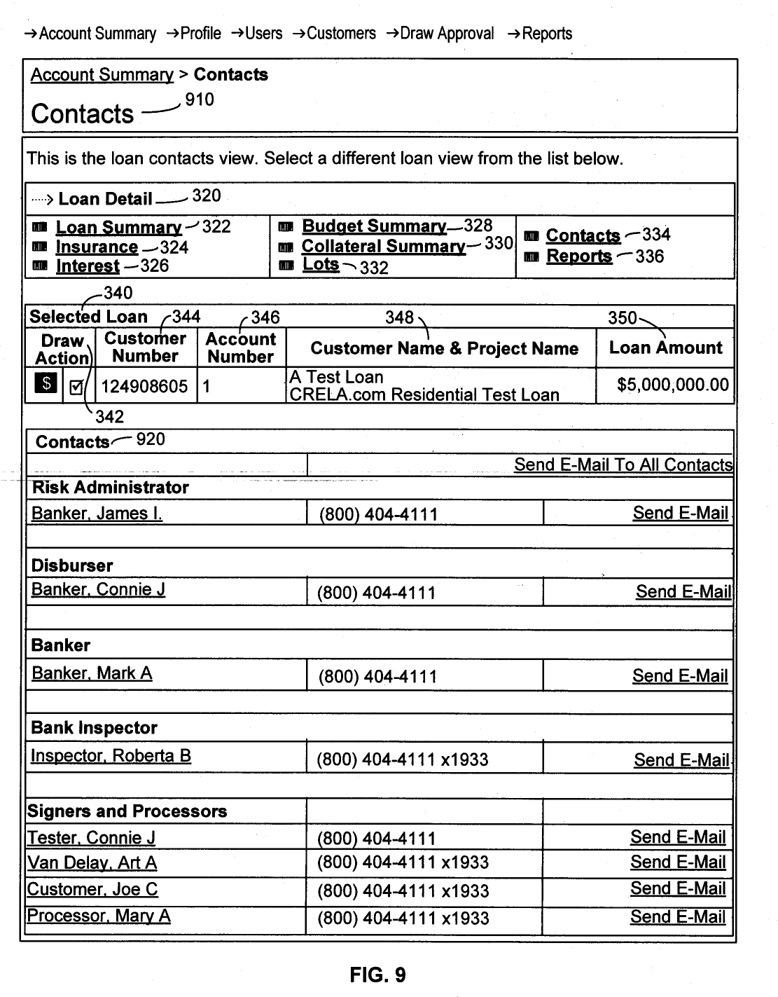

FIG. 10 is an exemplary interface for requesting a line item draw request, according to an embodiment of the present invention. Draw submissions may be requested for various lines of credit, including commercial, acquisition and development, custom home, working capital, letters of credit and others. As shown in FIG. 10, a selected loan may be displayed at 1010 with details including customer number 1012, account number 1014, customer name & project name 1016 and loan amount 1018. Other details may be displayed as well.

Draw Request Summary 1020 may include information regarding the draw request, such as Total Draw Request amount 1022, Total Equity Request amount 1024, Net Draw Request amount 1026 and Signer 1028 (or other authorized participant). By selecting 1030, the line item draw may be edited. Other actions may include delete 1032 and print draft request for loan advance letter 1034. The draw request may be submitted to a receiving entity, such as a bank or other financial institution, as shown by 1036.

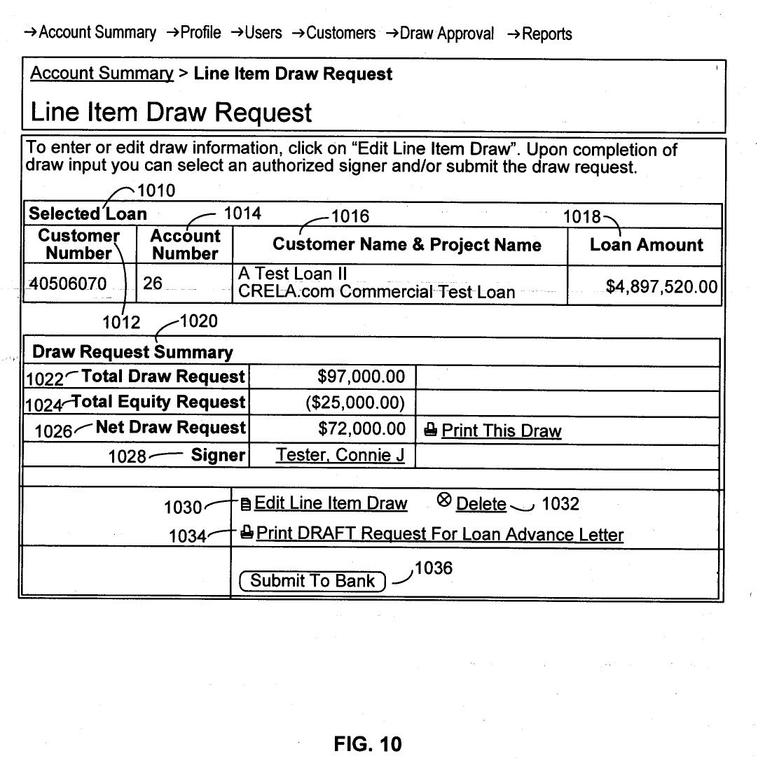

FIG. 11 is an exemplary interface for editing a line item draw, according to an embodiment of the present invention. According to one example, by selecting edit line item draw 1030 in FIG. 10, the user may view the interface of FIG. 11. Edit Line Item Draw Request 1110 enables a user to complete a draw request. Line Item Draw Request 1120 may include Line Item 1122, Description 1124, Current Available amount 1126, Current Request amount 1128, Balance amount 1130 and Transfer amount 1132. Other amounts and information may also be displayed. Net Draw Request 1134 and Total Adjustment 1136 provide total amounts. For example, the user may complete a draw request by entering a net line item draw amount(s) in the Current Request column 1128. The Balance column 1130 may update as the user completes the entries. To reallocate available funds, adjustments may be entered in the Transfer column 1132. Generally, the transfer will total zero. However, other applications may have a different total.

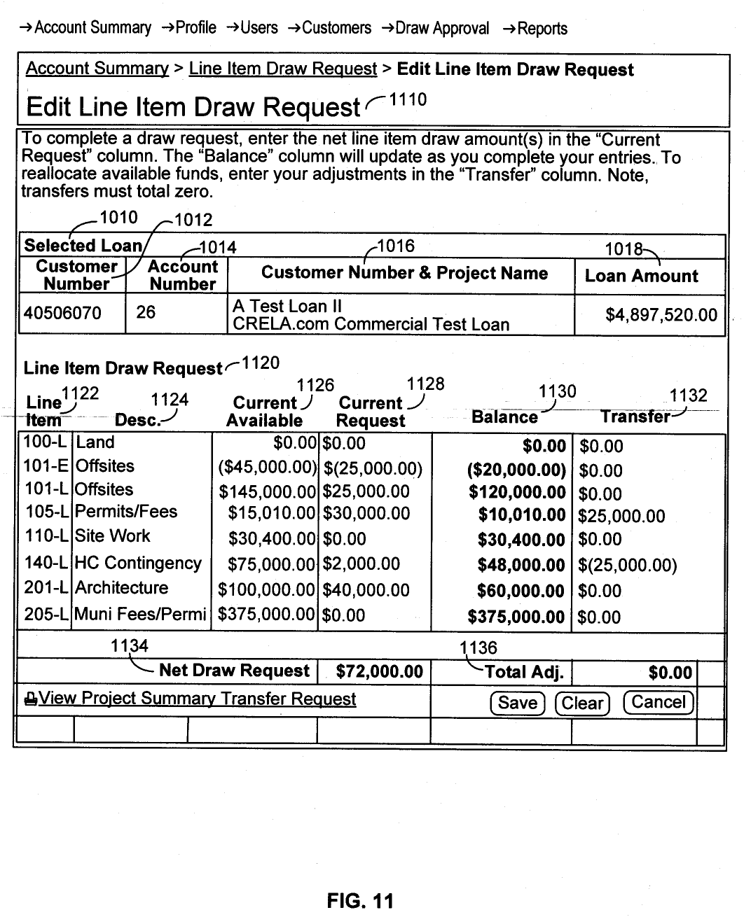

FIG. 12 is an exemplary interface for a unit draw request, according to an embodiment of the present invention. Draw requests may also include requests for residential construction, including new starts and units that are currently under construction, for example. For a selected loan 1210, customer number 1212 and customer name 1214 may be displayed. Draw Request Summary 1220 may provide information including Total New Starts Draw Request amount 1222, Total Existing Units Draw Request amount 1224, Total Draw Request amount 1226 and Signer 1228 (or other authorized participant). Other information concerning a draw request may also be displayed. To enter or edit draw information, the user may select new starts 1230 or existing units 1232. Other actions may include delete 1234 and print draft request for loan advance letter 1236, for example. The unit draw request may be submitted to a receiving entity, such as a bank or other financial institution, at 1238.

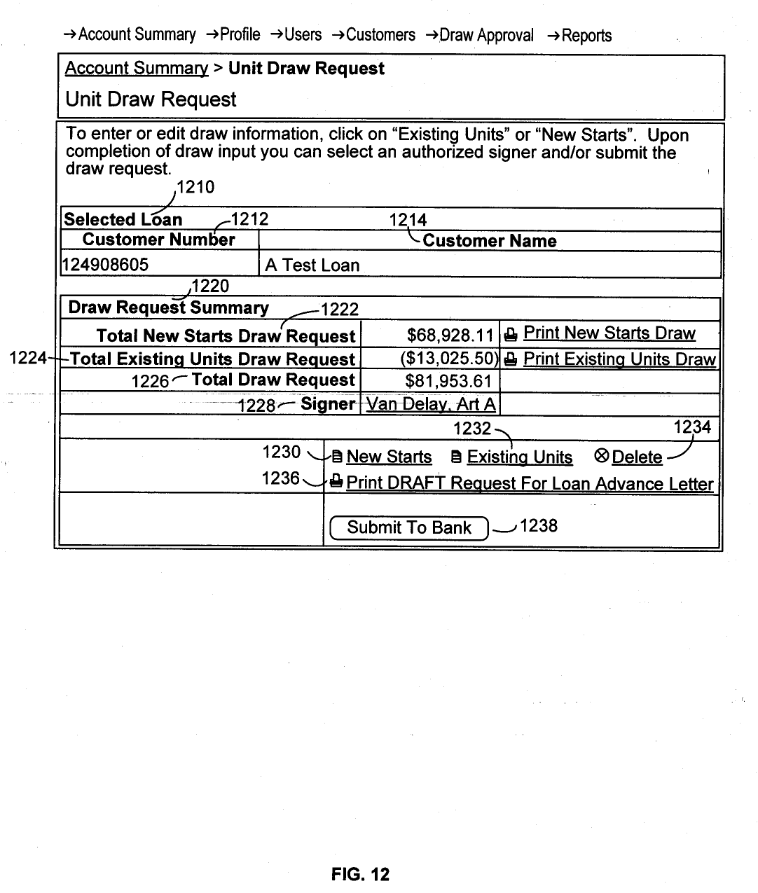

FIG. 13 is an exemplary interface for a new starts draw request, according to an embodiment of the present invention. To add a new start unit, link 1312 may be selected. To edit a new start, a lot identifier (e.g., sub code 1322) may be selected to select the unit. To delete a new start, the delete icon 1336 may be selected for the corresponding unit.

Selected loan 1210 may display information related to customer number 1212 and customer name 1214, for example. New Starts 1320 may display subdivision code 1322, lot number 1324, block 1326, status 1328 (e.g., presold, spec, undesignated, model, etc.), plan type 1330, percentage complete 1332, draw amount 1334, and delete unit 1336. Other information may also be displayed. Further, additional information may include total new starts draw (net) amount 1340, total amount due Acquisition & Development (A&D) 1342, total new starts draw amount 1344, total existing units draw amount 1346 and total draw amount 1348.

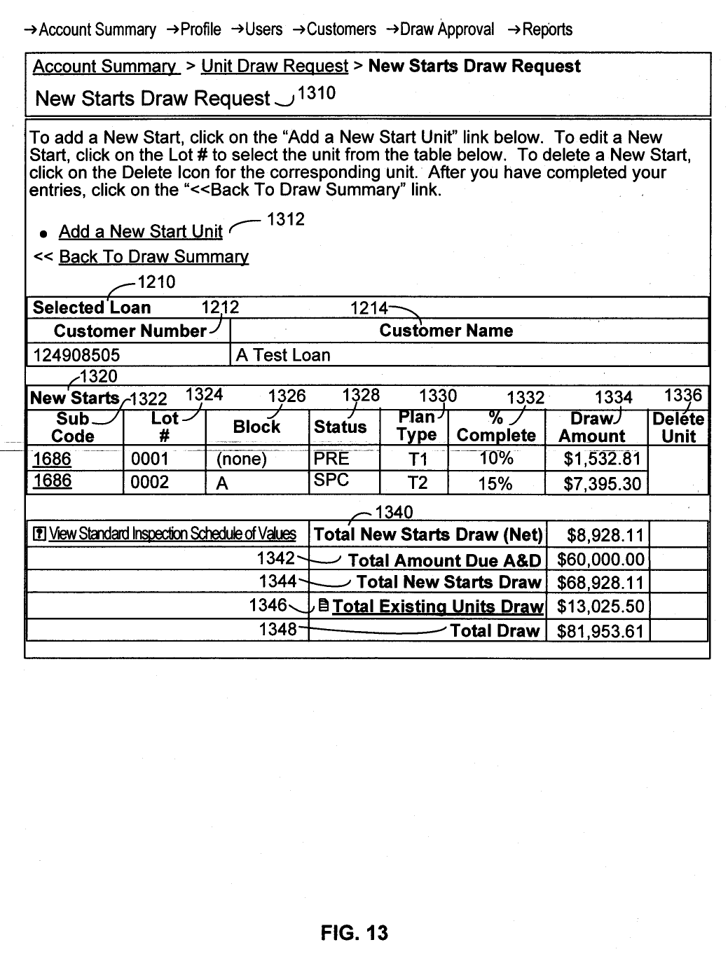

By selecting a unit (e.g., lot), draw request information may be modified, as shown in FIG. 14. An online draw submission may be completed to add new units to a revolving line of credit (or other financial instrument) with pre-programmed plan templates, which may include pre-approved cost and appraisal information as reviewed by a bank, base plan appraisals, base plan costs, etc. FIG. 14 is an exemplary interface for editing a new start unit, according to an embodiment of the present invention. Edit new start unit 1420 enables a user to edit various aspects of the new start unit, including subdivision name 1422, subdivision code 1424, plan type 1426, status 1428, sales price 1430, lot number 1432, block number 1434, percent complete 1436, and base sales 1438. Other data may be modified as well. Other information available to the user may include loan amount 1440, loan fee 1442, miscellaneous bank fees 1444, amount due A&D 1446, land draw amount 1448, soft cost draw amount 1450, hard cost draw amount 1452, net unit draw amount 1454 and/or other information.

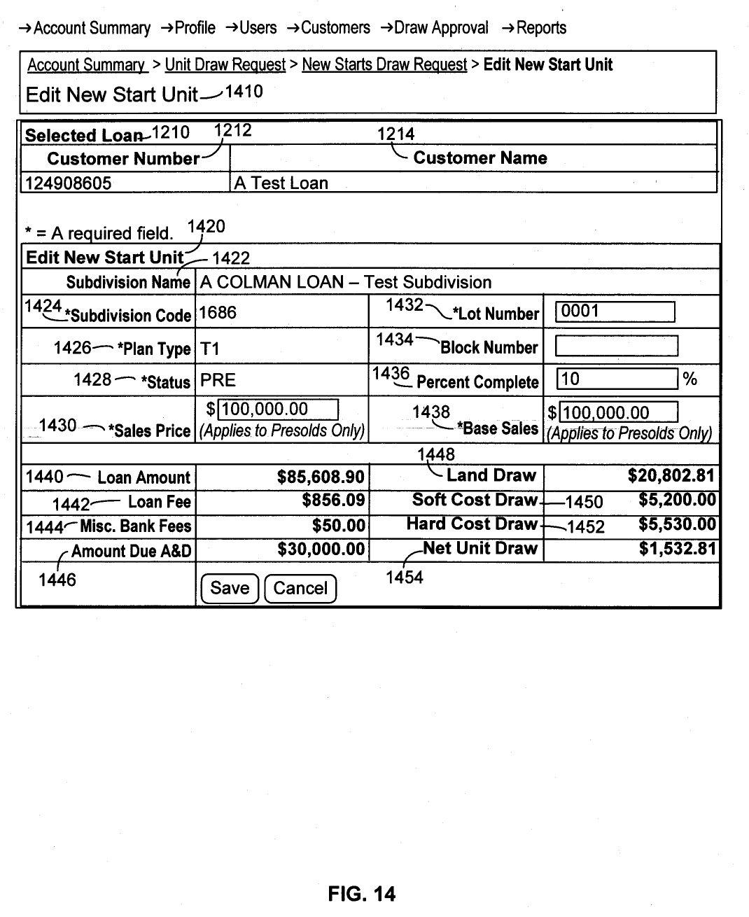

FIG. 15 is an exemplary interface for an existing units draw request, according to an embodiment of the present invention. To complete a draw, a unit's updated percentage complete or net dollar amount (or other measure) may be entered. Draw request method may be displayed at 1512, in this example, the draw request method is percent. The draw request method may be changed at 1514 to other measures, such as dollar amount.

Existing unit information may include subdivision code 1520, lot number 1522, block 1524, status 1526, construction funds 1528, construction funds disbursed 1530, percentage disbursed 1532, percentage requested 1534, and amount requested 1536. Other information including different formats of information may also be displayed. Additional information may include total existing units draw amount 1540, total new starts draw amount 1542 and total draw amount 1544. Other total data may be displayed.

Reports Module 142 enables a user (or other authorized participant) to generate various types of reports, including management reports for residential, commercial, acquisition and development, working capital, and/or other types of loans. For example, reports may be viewed by certain authorized individuals, which may depend on the project, type of project, authority, privileges, roles, and/or other criteria. Other reports may be viewed by all participants. Exemplary reports may include Lot Payoff Reports for displaying lot payoff information; Existing Unit Draw Request for displaying existing unit draw details; Lot Detail Report for displaying existing unit information by lot; Lot Payoff Report for displaying lot payoff detail; New Start Draw Request for displaying new start draw details; Plan Template Report for displaying unit plan information; Project Summary and Transfer Request for displaying line item draw details; Project Summary Report for displaying line item budgets and balances; Request for Loan Advance-Line Item for displaying blank line item request letter; Request for Loan Advance-Unit for displaying blank unit request letter; Transaction Detail Report for displaying detailed breakdown of loan transactions; and Transaction Summary Report for displaying brief summary of loan transactions. Other types of reports may be generated and further customized to individual user's needs and requests. Other reports may be available for internal employees (or other participant), pending draw requests, signers/processor, inspection firms, etc.

Collateral Module 144 provides the ability to update information, such as collateral information, and submit the updated information to a receiving entity, such as a bank or other lender entity. Users may also add new collateral, such as subdivisions, plans, unit collateral and other forms of collateral.

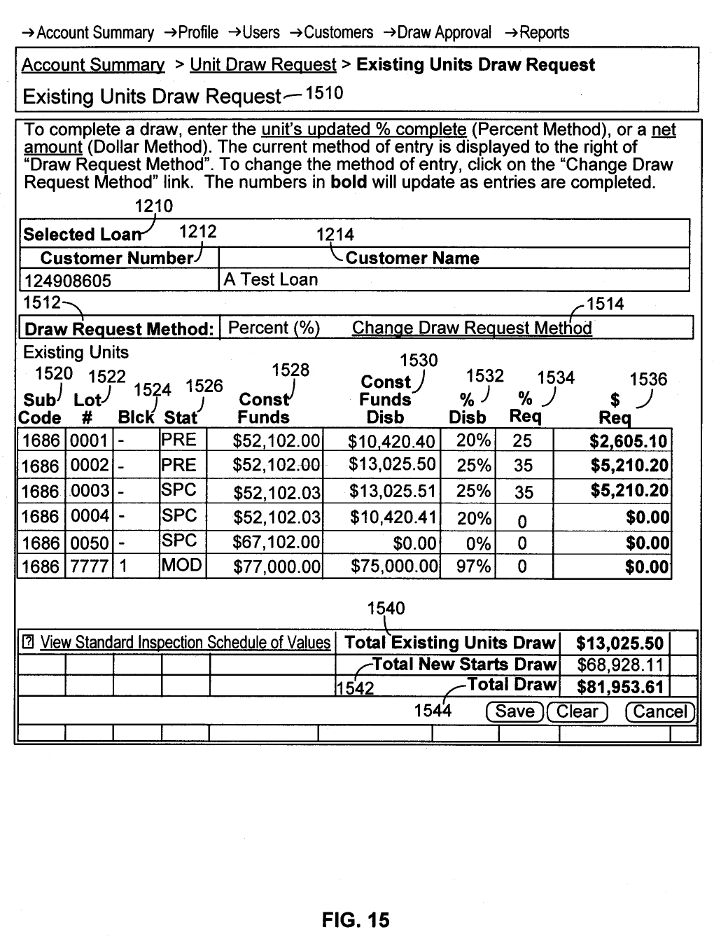

FIG. 16 is an exemplary illustration of a collateral module, according to an embodiment of the present invention. Collateral Module 144 may include Update Borrowing Base Module 1610, Add New Borrowing Base Module 1612, Add/Update Collateral Module 1614, Remove Collateral Module 1616, Analyze Collateral Data Module 1618, Reports Module 1620, and other module 1622.

An embodiment of the present invention enables a user to add one or more borrowing bases to a project or application. Information concerning the borrowing base may be added as a new borrowing base via Module 1612 or may update or replace an existing borrowing base via Module 1610. Borrowing base (e.g., collateral pool) may include a collection of collateral for a particular loan and/or project. Information may be submitted via an online interface, software which may be downloaded to a remote device and/or other modes of inputting and communicating information.

Add/Update Collateral Module 1614 enables a user to insert new collateral or update existing collateral data. Remove Collateral Module 1616 enables a user to remove collateral that may no longer be needed, eligible or has been paid off. Other edits may be made to collateral data through these modules.

Analyze Collateral Data Module 1618 may analyze data to determine eligibility and/or other conditions. Through this function, the collateral may be examined for meeting certain criteria. For example, this module may examine collateral for term (e.g., time on the base or other criteria) according to a Reclass date (or other attribute) of the collateral. This function may be evoked when an update is sent to a receiving entity, such as a bank or other financial institute.

Reports Module 1620 may include various reports associated with collateral data. For example, report options may include Base Detail, Subdivision Summary, State Summary, Sort Option, Loan Fees, and other types of reports. Base Detail report may provide a unit by unit detail of various fields. Subdivision Summary report may provide a comprehensive view of specific types of collateral by subdivision code (or other identifier or factor). State Summary report may provide a comprehensive view of collateral within a given state (or other geographic region). Sort Option report may put a unit detail report in order as specified. Loan Fees report may be used to calculate unit starts. The reports may be filtered by codes and/or other conditions. In addition, reports may be customized to display certain data, such as an address (e.g., address per unit, etc.), subdivision, status type and/or other characteristics.

In addition, a compliance worksheet may be generated where documentation, such as a collateral value certificate, may be attached. The compliance worksheet may provide a summary of some or all collateral and/or other conditions of a loan and/or project. For example, the compliance worksheet may identify compliance issues (e.g., loan requirements, etc.) related to a loan. For this report, the system may identify and add collateral values currently within a database (or other source of data which may be internal and/or external). For example, if units have been deleted as they close or the availability has been zeroed out, these actions may be reflected in the value. This process may add what is currently in the collateral value cell of each piece of collateral.

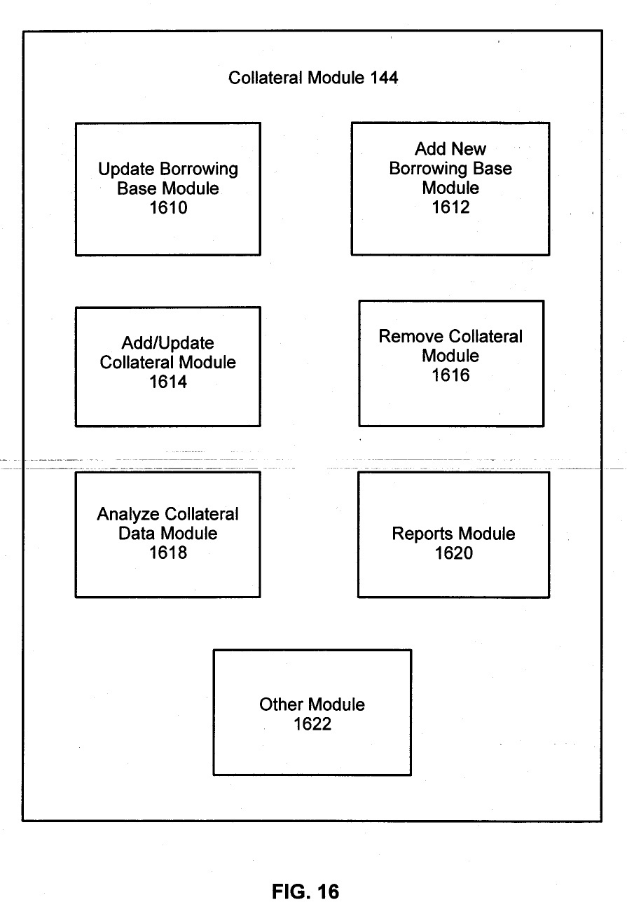

FIG. 17 is an exemplary illustration of a collateral page, according to an embodiment of the present invention. Collateral page 1700 may include Base View 1710, Subdivision View 1712, Plan View 1714, Unit View 1716, Collateral Update View 1718 and other view 1720 where other data may be displayed.

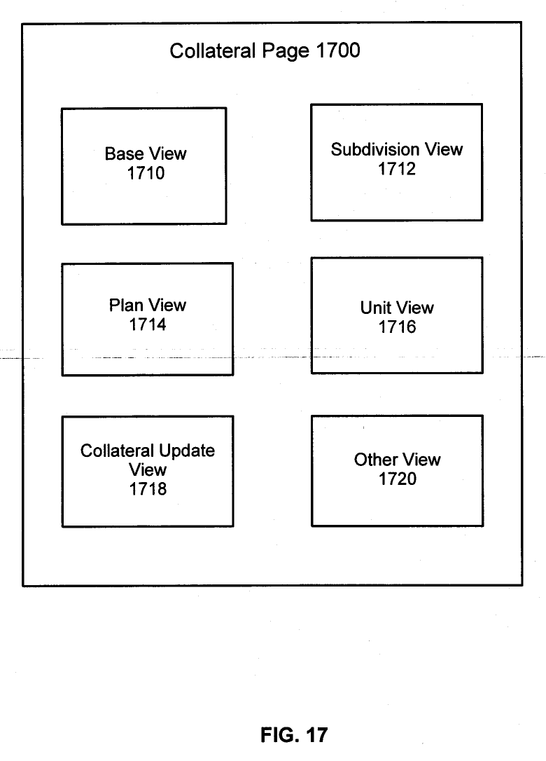

FIG. 18 is an exemplary illustration of a Base View, according to an embodiment of the present invention. Base View 1800 may be viewed by selecting Base tab 1810. Within Base tab 1810, icons may be displayed within pane 1812. Subdivisions 1814 and subdivision details 1816 may be displayed where subdivision details 1816 may include individual units or lots detail within a selected subdivision. At pane 1802, collateral details 1820 and borrower's information 1850 may be displayed. Collateral Details 1820 may include subdivision code 1822, block 1824, lot number 1826, unit status 1828, category or term 1830, first on base 1832, reclass date 1834, plan type 1836, percentage complete 1838 and street address 1840. Other information associated with collateral details may also be displayed.

Subdivision code 1822 may represent a code assigned by a bank (or other lender entity) and/or the borrower. Block 1824 may represent a block or tract within a legal description which describes the collateral. Lot number 1826 may represent which phase the collateral is located in (e.g., phase 3 lot 54 may be described as Lot Number 3054). Unit Status 1828 may include status descriptions which may be specific for a facility. For example, RAW may represent vacant land, A&D lot may represent a subdivision which is being developed and completed within a facility, IMP Lot may represent a lot which enters the base 100% complete, Spec may represent unsold unit, Presold may represent a unit under contract to a homebuyer, Model may represent a unit for show, Excess may represent ineligible collateral, No Dot may represent that the bank has no recorded deed or mortgage on this collateral, T/D Req may represent a lot which is given zero value because of lot takedown requirements within the loan agreement, ENT may represent entitled land or raw land, and LUD may represent A&D Lots or a subdivision being acquired and developed within a facility. Other status descriptions for other types of collateral and/or facilities may be used as well.

Category or Term 1830 may indicate the amount of time a piece of collateral has been in the facility based on a Reclass Date. This field may be represented in months (e.g., 0-9, 9-12, 12-15, 15+, etc.) or other time frames. First on Base 1832 may represent a date assigned by the system identifying the first time this collateral appeared on the borrowing base. Reclass Date 1834 may represent the date which will determine the life of a unit/lot. This date may be the same as First on Base until the status is changed from ineligible to eligible or a lot converts to a unit, for example. This date may be changed when any type of lot move to a unit type status occurs. For example, Plan Type 1836 may represent a plan type previously set up within a plan table. This may be tied to Base Appraisal, Budget Cost and/or Lot Allocation for each piece of collateral. Percentage Complete 1838 may represent percentage complete based on vertical construction or progress with an A&D, for example. A&D projects may be based on an overall average percentage of the project. Street Address 1840 may be include a street address or other identifier. This field may also be used as an information field.

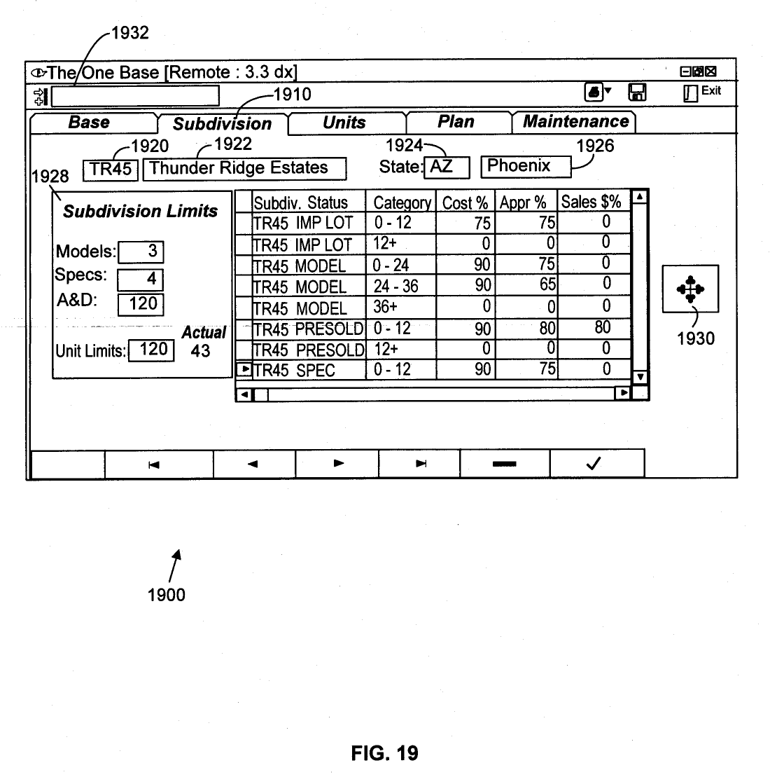

Borrower's Information 1850 may include Sales Price 1852, Budget Cost 1854, Land Cost 1856, Hard Cost 1858, Appraisal 1860, Lot Advance 1862, Max Allowed 1864 and Collateral Value 1866. Sales Price 1852 may be entered if a loan amount is based on using the sales price as a determining factor. Budget Cost 1854 may be populated from a Plan Table defined as Budget Cost, as described below as 2018 in FIG. 20. Land Cost 1856 and Hard Cost 1858 are not required fields and may be used for borrower information. Appraisal 1860 may be populated from the Plan Table defined as Base Appraisal, as described below as 2016 in FIG. 20. Lot Advance 1862 may be populated from the Plan Table defined as Lot Allocation, as described below as 2020 in FIG. 20. Max Allowed 1864 may represent a calculated loan amount for the collateral based on information previously added in other tables and/or other sources. Collateral Value 1866 may represent a current value for the collateral based on percentage complete (or other factor). For example, Maximum Allowed minus Lot Advance, times Percentage Complete, plus Lot Advance may be calculated to establish a unit/lot Collateral Value. Other calculations and/or representations may be used.

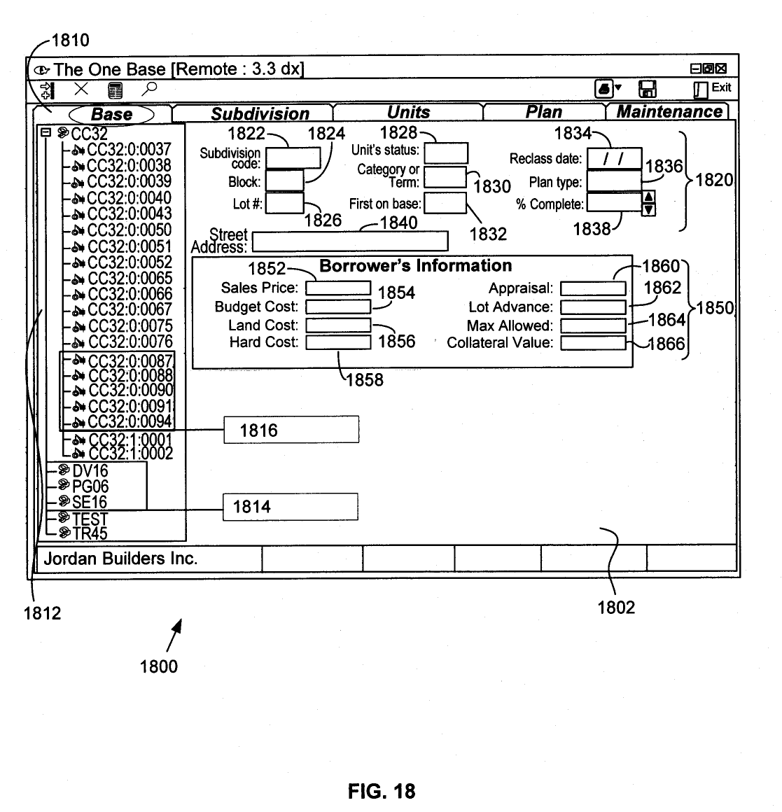

FIG. 19 is an exemplary illustration of a Subdivision View, according to an embodiment of the present invention. Subdivision View 1900 may be viewed by selecting Subdivision tab 1910. Subdivision View 1900 may provide an overview of subdivision criteria. Within Subdivision tab 1910, subdivision code 1920, subdivision name 1922, state code 1924, code 1926, subdivision limits 1928 and detailed view 1930. Other information may be displayed as well. A new subdivision may be added by selecting 1932.

For detailed view 1930, according to an exemplary application, 1930 may be a view only table where if criteria changes, the information may be updated by a lender entity (e.g., bank, etc.) and an update may be issued by the user. Subdivision code 1920 may be a numeric, alpha, alphanumeric code agreed upon by the user and the lender entity. This code may be used to define a lot/unit within a subdivision. Subdivision name 1922 identifies a marketing name, legal description or other term identifying the subdivision. State code 1924 identifies the state or other area which a user may want to track concentration within a particular geographic region of focus. Code 1926 may be used to further identify the state, a zip code or other identifier of a region.

Subdivision Limits 1928 provides limits set within the relevant loan agreement, which represents the maximum number of specific types of collateral allowed within a given subdivision. In this example, the subdivision has limits for models, specs and A&D. Other scenarios may involve other types of units/lots. Unit Limits may represent a maximum aggregate within the subdivision (or other criteria) and Actual may present a current number overall within this subdivision. Detailed View 1930 provides a view with updates on advance rates and/or terms on specific types of collateral approved for this subdivision. The information displayed may change on a subdivision by subdivision basis. As illustrated, the detailed information may include subdivision code, status, category, cost percentage, approximate percentage, sales percentage and/or other detailed information associated with a subdivision.

A new subdivision may be created by selecting 1932 where a new subdivision may be identified and relevant data (e.g., subdivision name, state, subdivision limits, etc.) may be entered.

FIG. 20 is an exemplary illustration of a Plan View, according to an embodiment of the present invention. Plan View 2000 may be viewed by selecting Plan tab 2010. Plan View 2000 may provide a grid format for data pertaining to plan appraisals, budget costs, lot allocations and/or other factors. Information may be entered for specific subdivision codes and plan types, etc. Plan View 2000 may include Subdivision 2012, Plan 2014, Base Appraisal 2016, Budget Cost 2018, Lot Draw or Lot Allocation 2020, Base Sales 2022 and/or other plan data. Subdivision 2012 may represent a code assigned to a given subdivision. Plan 2014 may represent a plan code identifying each plan in any subdivision. Base Appraisal 2016 may represent an appraisal to be used with the specific plan type within this particular subdivision. This may represent the data used to determine a Loan to Value criteria in a loan. Budget Cost 2018 may represent the budget amount as defined within a loan agreement. This may represent the data used to determine a Loan to Cost criteria, which may be typically inclusive of hard costs (e.g., tangible costs, such as bricks, material, dirt movement, etc.) and/or soft costs (e.g., intangible costs, such as marketing, fees, permits, etc.) including land. Lot Draw or Lot Allocation 2020 may represent an amount advance prior to any percentage of completion and may be defined in a loan agreement. For ENT Lots (e.g., entitled land, raw land, etc.), this value may be zero. For Improved Lots, this value may be at 100% complete. Base sales 2022 may represent a field used for additional information.

In addition, a new plan may be created by selecting 2030. Information pertaining to approved appraisal, budget cost and lot allocation per plan type may be entered. Other information may be included as well. This information maybe supplied from the lender entity (e.g., bank) or other source of data.

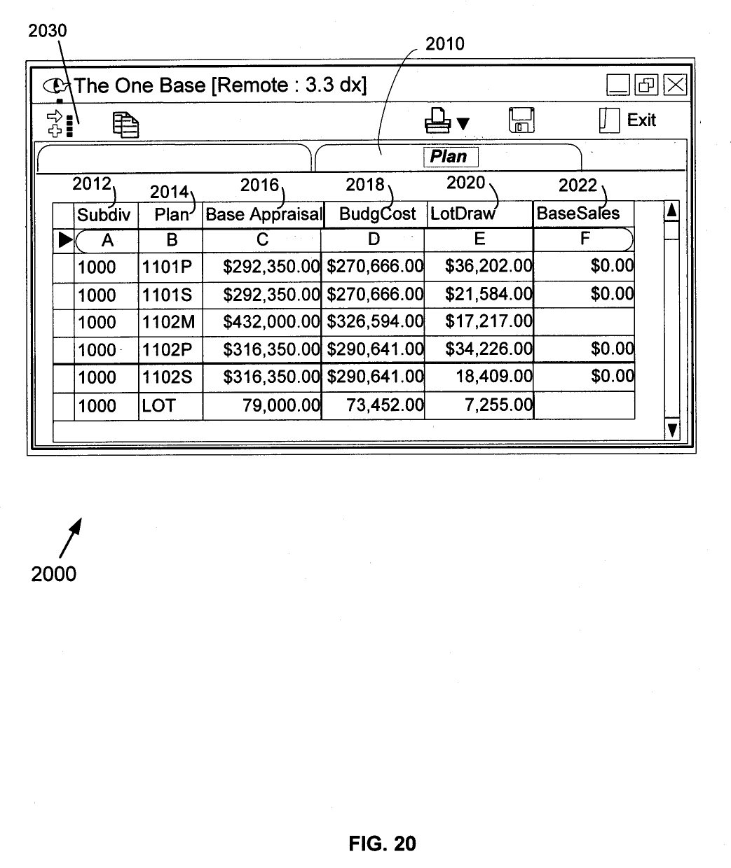

FIG. 21 is an exemplary illustration of a Unit View, according to an embodiment of the present invention. Unit View 2100 may be viewed by selecting a Unit tab 2110 from a subdivision display as displayed at the Base View 1800. Unit View 2100 displays data for updating collateral in subdivison(s). Unit View 2100 may display Subdivision 2112, Block 2114, Lot 2116, Plan 2118, Status 2120, Category 2122, Sales Price 2124, Percent Complete 2126, Remote Total Available 2128, Remote Maximum Available 2130, Remote First Advance 2132 and/or other data that may be updated and/or otherwise modified. Remote data may represent data entered by a customer or other associated participant. Data may be updated by entering updated data or selecting an option from a drop down menu. Other methods for updating data may be implemented.

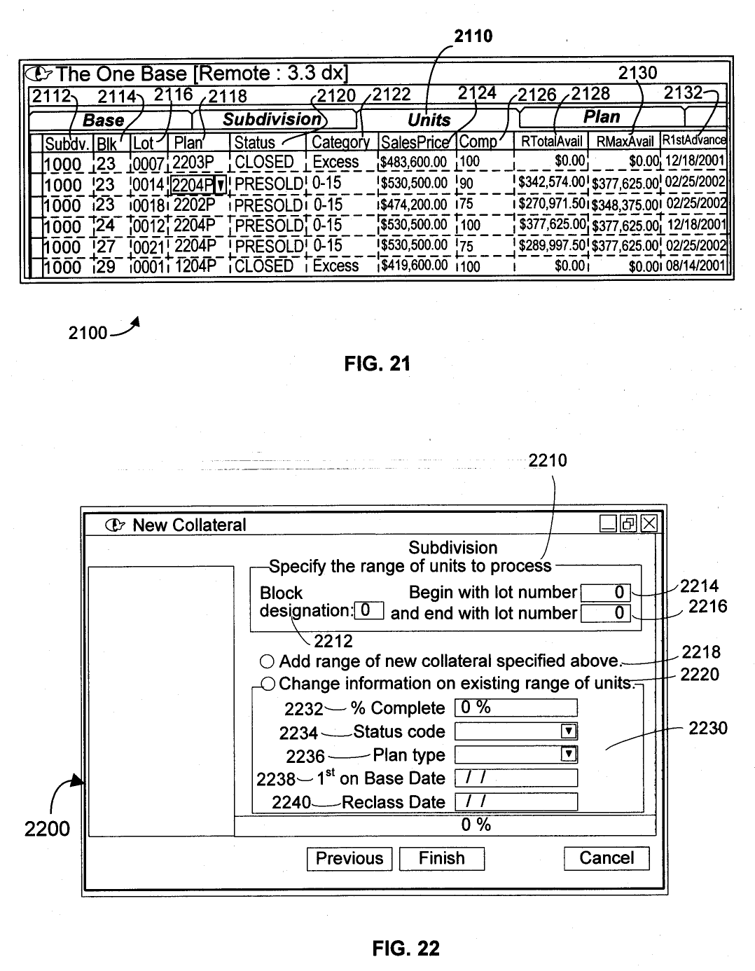

FIG. 22 is an exemplary illustration of a Collateral Update View, according to an embodiment of the present invention. According to another example, collateral data may be inserted and/or updated in bulk. A subdivision may be selected for adding or updating collateral within the subdivision. A range of units may be selected to initiate the updates, at 2210. For example, a block designation 2212 may be identified. In addition, a begin lot number 2214 and an end lot number 2216 may be identified. For a single unit, the begin and end lot numbers should be the same. A user may specify whether the range entered in 2210 specifies new collateral by selecting 2218. A user may also specify whether information is being changed (or updated) on an existing range of units by selecting 2220. Other options for updating data may be provided as well. Various data pertaining to units within a subdivision may be updated and/or added. For example, the data may include Percentage Compete 2232, Status Code 2234, Plan type 2236, First on Base Date 2238, Reclass Date 2240 and/or other data. For example, Status Code 2234 and Plan type 2236 data may be updated by selecting an option from a drop down menu which ensures that the input will match with what was programmed into the system and/or previously authorized. Other data may be added and/or modified as well.

Import Module 146 provides the ability to update information, such as collateral information, and import the revised information to a receiving entity, such as a bank or other lender entity. Information in the import may be considered to be in a pending state until the receiving entity imports the information into a local application.

Export Module 148 provides the ability to update information, such as collateral information, on a remote program. Users may select an export option to transfer files from the online system to a remote device, such as a personal computer or other remote device (e.g., personal digital assistant (PDA), wireless device, wireline device, etc.). For example, data may be exported to a selected drive (or other destination) for an update before submission to a lender entity, such as a bank.

Users may select and customize the information to be exported. Users may apply customized filters for downloading relevant information. Examples of filters may include operators (e.g., add, or, not, etc.), match criteria (e.g., equal, less than, greater than, etc.), string to compare (e.g., “status”=“Presold”), and other forms of filtering. Collateral information for a specific loan within a specific date range and meeting certain defined conditions may be exported. For example, all presolds within a given subdivision less than 10% complete may be identified by selecting “Status”=“Presold” and “% Complete”—less than −10. The filtered data maybe downloaded to an application, such as a spreadsheet. From the application (e.g., spreadsheet, etc.), the user may sort, mix or filter within the filtered data. This may be helpful in projections pertaining to collateral reaching term, concentration concerns, percentage complete and various other scenarios.

Notification Module 150 may inform various participants of certain events, conditions and/or information. A user may assign triggering events, such as a draw request, draw approval, LIBOR, interest rate increase/decrease, and other actions or occurrences associated with real estate loan administration. A preferred mode of notification may also be identified. For example, a user may select to be notified by email, phone, fax, pager, etc. In addition, a tiered notification mode may be applied where the user is first notified by email and followed-up with a phone call. Other variations may be implemented. The user may also identify the individuals and/or entities to be notified via various preferred modes of notification. For example, if the interest rate decreases by 0.5% or reaches a specified percentage (e.g., 7.5%), a notification may be sent to the identified recipients via a preferred mode of notification where each (or some) recipient may be assigned different modes of notification. Attachments and/or other information may be forwarded with the notification. For example, when an insurance is about to expire, a user may be notified at predetermined time in advance (e.g., 2 days prior to expiration) where an attachment, such as an image of an insurance certificate or other documentation, may be forwarded to the intended recipient. In another example, certain actions may be performed, in response to a defined triggering event. For example, a specified type of report may be automatically generated in response to a predefined triggering event, such as the end of each week. In another example, a user may select to be notified via email when any draw action is performed. The user may also specify the level of detail of the notification, such as the requester of the draw action, amount, time of action, etc.

Collaboration Module 152 provides various participants the ability to collaborate with each other. For example, certain documents may be shared with the various participants. Privileged or other documents deemed sensitive may be authorized to be viewed by select participants, or individuals with certain roles (e.g., signer, processor, etc.). Documents may include graphics, photographs, and other data/information viewable on a screen or an interface. An online chat board, video conference module or other communication interface may be provided for real time communication. Various third party individuals may have access to the collaboration module. Third party individuals may include consultants, attorneys, and/or other individuals. Such individuals may be assigned various types of access ability, such as view only, view only certain documents, folders, etc.

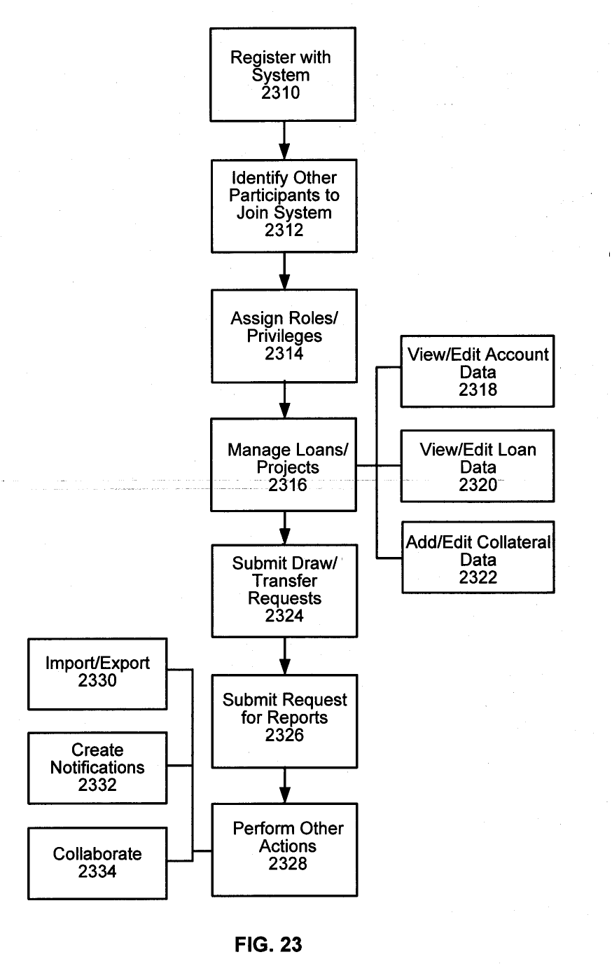

FIG. 23 is an exemplary flowchart illustrating a method for loan administration, according to an embodiment of the present invention. At step 2310, a user may register with the system for loan administration. The user may receive a user identifier and a password (or PIN) for access to the system for loan administration. At step 2312, the user may identify other participants associated with a loan or project to join the system for loan administration. At step 2314, the user may assign roles and/or privileges to each participant or group of participants. For example, certain participants may view certain documents and/or perform certain actions associated with the loan or project. At step 2316, the user may manage the various loans and/or projects. For example, the user may view/edit account data at 2318, view/edit loan data at 2320 and add/edit collateral data at 2322. Data may be examined in various levels of detail. Other actions associated with managing loans and/or projects may be performed as well. At step 2324, the user (or other authorized participant) may submit draw and/or transfer requests. At step 2326, the user (or other authorized participant) may request various types of reports to be generated based on user defined specifics. At step 2328, other actions may be performed, which may include importing data and/or exporting data at 2330; creating notifications at 2332 and collaborating with other participants and/or third parties at 2334. Other actions associated with loan administration may also be performed.

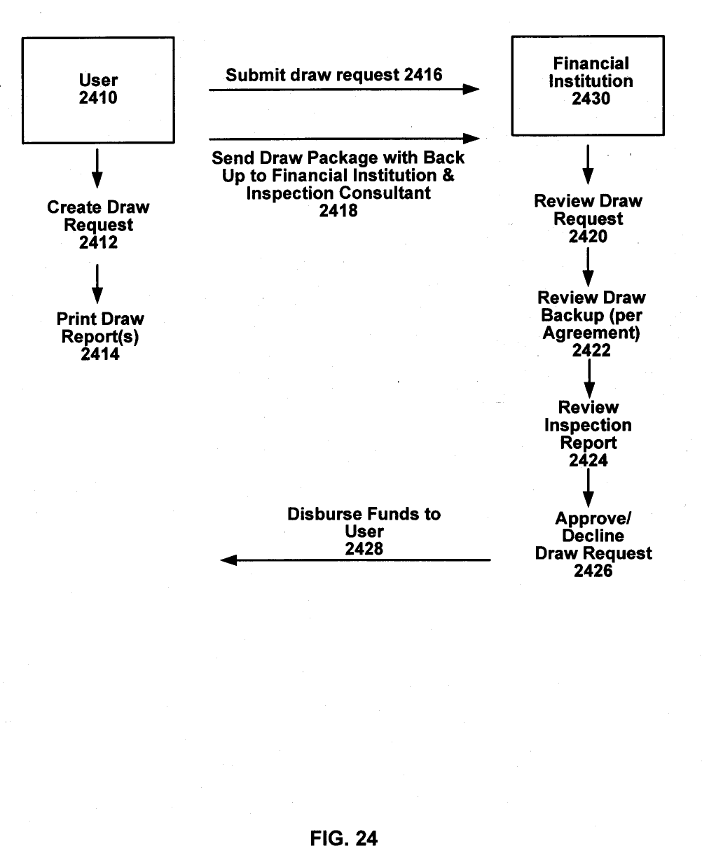

FIG. 24 is an exemplary flow diagram illustrating a draw request process, according to an embodiment of the present invention. In this exemplary scenario, a user 2410 (or other authorized entity, customer, etc.) may create a draw request at 2412, the draw request may be created online through the system of an embodiment of the present invention. The user 2410 may print or otherwise download draw reports based on various specifics at 2414. The user may submit the draw request at 2416 to a receiving entity, such as a financial institution 2430, bank or other lender entity. User 2410 may also send a draw package which may include a request for a loan advance, invoices, lien waivers, sales contract, or other request with a backup to the Financial Institution 2430 and/or Inspection Consultant, which may be associated with the Financial Institution 2430 or a separate entity.

Financial Institution 2430 may review the draw request at 2420, which may be received via an online communication. Financial Institution 2430 may review the draw backup at 2422, in accordance with an agreement, which may include required loan documentation per the note and/or loan agreement. Financial Institution 2430 may review reports, such as an inspection report at 2424. The inspection report may refer to a documentation of a thorough examination of a structure's (e.g., house, building, etc.) visible structural parts and systems, conducted before purchase. A decision may be made whether to approve or decline the draw request at 2426. If the draw request is approved, funds may be disbursed to the user at 2428. The user may specify the receiving entity, account or other recipient of the funds.

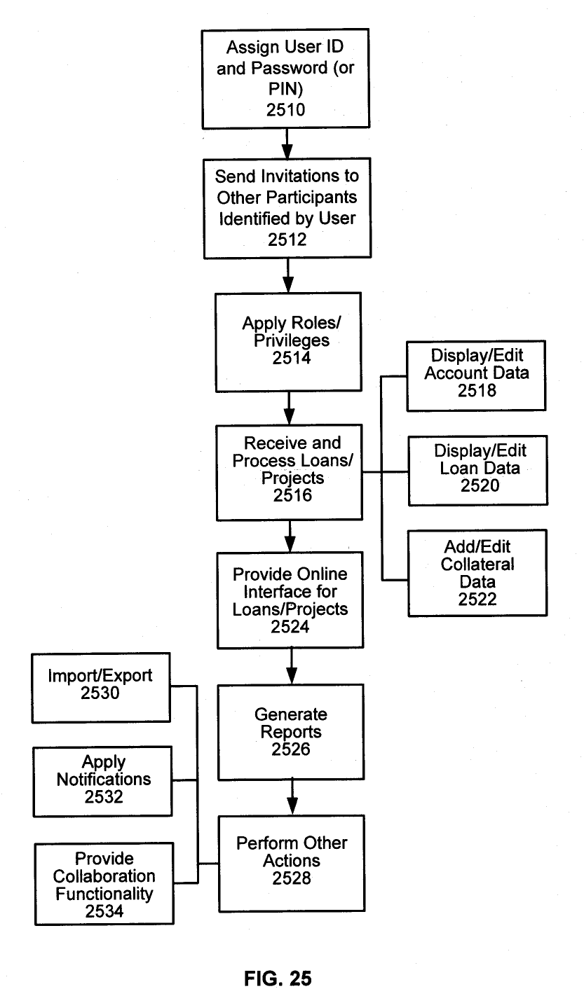

FIG. 25 is an exemplary flowchart illustrating a method for loan administration, according to an embodiment of the present invention. At step 2510, a system of an embodiment of the present invention may assign a user identifier and password (or PIN) to a user upon user registration. At step 2512, the system may send invitations to identified participants to join the system to access data associated with a loan or project. At step 2514, the roles and/or privileges assigned by the user may be applied to each participant or group of participants. For example, certain participants may view certain documents and/or perform certain actions associated with the loan or project. The system may apply default roles and/or privileges to participants that have not been assigned specific roles and/or privileges. At step 2516, the system may gather data associated with the loans and/or projects, process the information and provide an online interface for the user to manage the various loans and/or projects. For example, the system may display/edit account data at 2518, display/edit loan data at 2520 and add/edit collateral data at 2522. Other actions associated with managing loans and/or projects may be performed as well. At step 2524, the system may receive draw and/or transfer requests from the user (or other authorized participant) and process such requests for submission to an appropriate receiving entity, such as lender, bank, etc. At step 2526, the system may generate various types of reports as requested by the user (or other authorized participant). At step 2528, other actions may be performed, which may include importing data and/or exporting data at 2530; applying notifications defined by the user (or other authorized participant) at 2532 and providing collaboration functionality with other participants and/or third parties at 2534. Other actions associated with loan administration may also be provided.

According to an embodiment of the invention, the systems and processes described in this invention may be implemented on any general or special purpose computational device, either as a standalone application or applications, or even across several general or special purpose computational devices connected over a network and as a group operating in a client-server mode. According to another embodiment of the invention, a computer-usable and writeable medium having a plurality of computer readable program code stored therein may be provided for practicing the process of the present invention. The process and system of the present invention may be implemented within a variety of operating systems, such as a Windows® operating system, various versions of a Unix-based operating system (e.g., a Hewlett Packard, a Red Hat, or a Linux version of a Unix-based operating system), or various versions of an AS/400-based operating system. For example, the computer-usable and writeable medium may be comprised of a CD ROM, a floppy disk, a hard disk, or any other computer-usable medium. One or more of the components of the system or systems embodying the present invention may comprise computer readable program code in the form of functional instructions stored in the computer-usable medium such that when the computer-usable medium is installed on the system or systems, those components cause the system to perform the functions described. The computer readable program code for the present invention may also be bundled with other computer readable program software. Also, only some of the components may be provided in computer-readable code.

Additionally, various entities and combinations of entities may employ a computer to implement the components performing the above-described functions. According to an embodiment of the invention, the computer may be a standard computer comprising an input device, an output device, a processor device, and a data storage device. According to other embodiments of the invention, various components may be computers in different departments within the same corporation or entity. Other computer configurations may also be used. According to another embodiment of the invention, various components may be separate entities such as corporations or limited liability companies. Other embodiments, in compliance with applicable laws and regulations, may also be used.

According to an embodiment of the present invention, the system may comprise components of a software system. The system may operate on a network and may be connected to other systems sharing a common database. Other hardware arrangements may also be provided.

Other embodiments, uses and advantages of the present invention will be apparent to those skilled in the art from consideration of the specification and practice of the invention disclosed herein. The specification and examples should be considered exemplary only. The intended scope of the invention is only limited by the claims appended hereto.

While the invention has been particularly shown and described within the framework of real estate loan administration, it will be appreciated that variations and modifications can be effected by a person of ordinary skill in the art without departing from the scope of the invention. Furthermore, one of ordinary skill in the art will recognize that such processes and systems do not need to be restricted to the specific embodiments described herein.

1. A computer implemented method for construction loan administration, wherein the method is carried out, at least in part, using a system comprising a computer processor, the method comprising the steps of:
registering, through the computer processor, with the system for construction loan administration wherein at least one loan is identified and the at least one loan comprises an existing construction loan;
identifying one or more participants associated with the at least one loan to join the system for construction loan administration;
assigning, through the computer processor, one or more of privileges and roles to each of the one or more participants;
managing the at least one loan via the computer processor of the system through an online interface wherein data associated with the at least one loan may be accessed and viewed according to user input
accessing, by the computer processor, loan data specific for the at least one loan wherein the loan data comprises budget summary data, wherein the budget summary data comprises a line item budget and a disbursed amount;
performing, by the computer processor, one or more actions concerning the at least one loan wherein the one or more actions comprise at least submitting information to a receiving entity and submitting one or more draw requests wherein the draw requests are based on one or more stages of construction;
specifying, through the computer processor, one or more triggering events associated with the at least one loan;
specifying, through the computer processor, one or more contacts to be notified after an occurrence of the one or more triggering events; and
specifying, through the computer processor, one or more preferred modes of notification for the one or more contacts at the occurrence of the one or more triggering events.

2. The method of claim 1, wherein the loan data further comprises one or more of insurance data, and interest data.

3. The method of claim 1, wherein the step of managing further comprises the step of:
accessing, by the computer processor, collateral data associated with the at least one loan.

4. (canceled)

5. The method of claim 1, wherein the one or more draw requests comprise line item draw requests.

6. The method of claim 1, wherein the one or more draw requests comprise unit draw requests for one or more of new starts and existing units.

7. The method of claim 1, wherein the step of registering with the system further comprises the steps of:
identifying, through the computer processor, one or more of insurance, interest, budget, collateral and contact information associated with each loan.

8. The method of claim 1, further comprising the step of:
requesting, through the computer processor, one or more reports to be generated for the at least one loan based on one or more user defined specifics.

9. The method of claim 1, wherein the step of performing one or more actions comprises the step of:
adding, through the computer processor, collateral data for at least one new collateral associated with the loan.

10. The method of claim 1, wherein the step of performing one or more actions comprises the step of:
updating, through the computer processor, collateral data for at least one collateral associated with the loan.

11. The method of claim 10, wherein collateral data comprises one or more of plan type, status, sales price, amount complete and remote cost data.

12. The method of claim 11, further comprising the step of:
analyzing the collateral data to determine collateral eligibility.

13. The method of claim 11, further comprising the step of:
generating, by the computer processor, a compliance worksheet for identifying one or more compliance issues associated with the at least one loan.

14. The method of claim 1, further comprising the step of:
updating, through the computer processor, data associated with the at least one loan; and
importing, by the computer processor, the updated data to a receiving entity.

15. The method of claim 14, wherein the data comprises collateral data concerning one or more pieces of collateral associated with the at least one loan and wherein the receiving entity is a lender entity and the collateral data comprises one or more of plan type, status, sales price, amount complete and remote cost data.

16. The method of claim 1, further comprising the step of:
updating, through the computer processor, data associated with the at least one loan;
specifying, through the computer processor, one or more filters to be applied to the updated data; and
exporting, by the computer processor, the filtered updated data from the system for construction loan administration to a remote device.

17. The method of claim 16, wherein the data comprises collateral data comprising one or more of plan type, status, sales price, amount complete and remote cost data.

18. The method of claim 16, wherein the remote device comprises one or more of a personal computer, personal digital assistant and wireless device.

19. (canceled)

20. The method of claim 1, further comprising the step of:
authorizing, through the computer processor, one or more participants for collaboration; and
assigning, through the computer processor, one or more of roles and privileges for collaboration to each participant.

21. The method of claim 20, wherein one or more documents may be shared simultaneously with the authorized one or more participants via a common online interface.

22. The method of claim 1, wherein the receiving entity is a lender entity.

23. A computer implemented system for construction loan administration comprising:
a computer processor;
a computer memory;
a registration module for registering with the system for construction loan administration wherein at least one loan is identified and the at least one loan comprises an existing construction loan;
an invitation module for identifying one or more participants associated with the at least one loan to join the system for construction loan administration; and assigning one or more of privileges and roles to each of the one or more participants; and
a loan module for managing the at least one loan via the system through an online interface wherein data associated with the at least one loan is accessed and viewed according to user input, wherein the data associated with the at least one loan comprises budget summary data, wherein the budget summary data comprises a line item budget and a disbursed amount;
and performing one or more actions concerning the at least one loan wherein the one or more actions comprise at least submitting information to a receiving entity and wherein the one or more actions comprise submitting one or more draw requests wherein the draw requests are based on one or more stages of construction.

24. The system of claim 23, wherein the data comprises one or more of insurance data, and interest data.

25. The system of claim 23, wherein collateral data associated with the at least one loan is accessed.

26. (canceled)

27. The system of claim 23, wherein the one or more draw requests comprises line item draw requests.

28. The system of claim 23, wherein the one or more draw requests comprises unit draw requests for one or more of new starts and existing units.

29. The system of claim 23, wherein one or more of insurance, interest, budget, collateral and contact information is associated with each loan.

30. The system of claim 23, further comprising:
a reports module for requesting one or more reports to be generated for the at least one loan based on one or more user defined specifics.

31. The system of claim 23, further comprising:
a collateral module for adding collateral data for at least one new collateral associated with the loan.

32. The system of claim 23, further comprising:
a collateral module for updating collateral data for at least one collateral associated with the loan.

33. The system of claim 32, wherein the collateral data comprises one or more of plan type, status, sales price, amount complete and remote cost data.

34. The system of claim 33, wherein the collateral data is analyzed to determine collateral eligibility.

35. The system of claim 33, wherein a compliance worksheet is generated for identifying one or more compliance issues associated with the at least one loan.

36. The system of claim 23, further comprising:
an import module for updating data associated with the at least one loan and importing the updated data to a receiving entity.

37. The system of claim 36, wherein the data comprises collateral data concerning one or more pieces of collateral associated with the at least one loan and wherein the receiving entity is a lender entity and the collateral data comprises one or more of plan type, status, sales price, amount complete and remote cost data.

38. The system of claim 23, further comprising:
an export module for updating data associated with the at least one loan; specifying one or more filters to be applied to the updated data; and exporting the filtered updated data from the system for construction loan administration to a remote device.

39. The system of claim 38, wherein the data comprises collateral data comprising one or more of plan type, status, sales price, amount complete and remote cost data.

40. The system of claim 38, wherein the remote device comprises one or more of a personal computer, personal digital assistant and wireless device.

41. The system of claim 23, further comprising:
a notification module for specifying one or more triggering events associated with the at least one loan; specifying one or more contacts to be notified at an occurrence of the one or more triggering events; and specifying one or more preferred modes of notification for the one or more contacts at the occurrence of the one or more triggering events.

42. The system of claim 23, further comprising:
a collaboration module for authorizing one or more participants for collaboration; and
assigning one or more of roles and privileges for collaboration to each participant.

43. The system of claim 42, wherein one or more documents are shared simultaneously with the authorized one or more participants via a common online interface.

44. The system of claim 23, wherein the receiving entity is a lender entity.

45. A computer implemented method for providing construction loan administration, wherein the method is carried out, at least in part, using a system comprising a computer processor, the method comprising the steps of:
enabling, by the computer processor, a user to register with the system for construction loan administration wherein at least one loan is identified by the user and the user is assigned a user identifier and a password, and the at least one loan comprises an existing construction loan;
sending, by the computer processor, a message to one or more participants associated with the at least one loan to join the system for construction loan administration wherein the one or more participants are identified by the user;
applying, by the computer processor, one or more of privileges and roles to each of the one or more participants wherein the one or more privileges and roles are assigned by the user;
processing data associated with the at least one loan via the system through an online interface;
accessing, by the computer processor, loan data specific for the at least one loan wherein loan data comprises budget summary data;
performing, by the computer processor, one or more actions concerning the at least one loan wherein the one or more actions comprise at least submitting information to a receiving entity and submitting one or more draw requests wherein the draw requests are based on one or more stages of construction;
identifying, through the computer processor, one or more triggering events associated with the at least one loan;
identifying, through the computer processor, one or more contacts to be notified after an occurrence of the one or more triggering events;
identifying, through the computer processor, one or more preferred modes of notification for the one or more contacts after the occurrence of the one or more triggering events; and
generating, by the computer processor, a notification to be sent to the one or more contacts after the occurrence of the one or more triggering events via the one or more preferred modes of notification.

46. The method of claim 45, wherein the loan data comprises one or more of insurance data, and interest data.

47. The method of claim 45, wherein the step of processing further comprises the step of:
accessing, by the computer processor, collateral data associated with the at least one loan.

48. (canceled)

49. The method of claim 45, wherein the one or more draw requests comprises line item draw requests.

50. The method of claim 45, wherein the one or more draw requests comprises unit draw requests for one or more of new starts and existing units.

51. The method of claim 45, wherein the user provides one or more of insurance, interest, budget, collateral and contact information associated with each loan.

52. The method of claim 45, further comprising the step of:
generating, by the computer processor, one or more reports for the at least one loan based on one or more user defined specifics.

53. The method of claim 45, wherein the step of performing one or more actions comprises the step of:
adding, by the computer processor, collateral data for at least one new collateral associated with the loan.

54. The method of claim 45, wherein the step of performing one or more actions comprises the step of:
updating, by the computer processor, collateral data for at least one collateral associated with the loan.

55. The method of claim 54, wherein collateral data comprises one or more of plan type, status, sales price, amount complete and remote cost data.

56. The method of claim 55, further comprising the step of:
analyzing, by the computer processor, the collateral data to determine collateral eligibility.

57. The method of claim 55, further comprising the step of:
generating, by the computer processor, a compliance worksheet for identifying one or more compliance issues associated with the at least one loan.

58. The method of claim 45, further comprising the step of:
updating, by the computer processor, data associated with the at least one loan; and
importing, by the computer processor, the updated data to a receiving entity.

59. The method of claim 58, wherein the data comprises collateral data concerning one or more pieces of collateral associated with the at least one loan and wherein the receiving entity is a lender entity and the collateral data comprises one or more of plan type, status, sales price, amount complete and remote cost data.

60. The method of claim 45, further comprising the step of:
updating, by the computer processor, data associated with the at least one loan;
identifying, by the computer processor, one or more filters to be applied to the updated data; and
exporting, by the computer processor, the filtered updated data from the system for construction loan administration to a remote device.

61. The method of claim 60, wherein the data comprises collateral data comprising one or more of plan type, status, sales price, amount complete and remote cost data.

62. The method of claim 60, wherein the remote device comprises one or more of a personal computer, personal digital assistant and wireless device.

63. (canceled)

64. The method of claim 45, further comprising the step of:
authorizing, by the computer processor, one or more participants for collaboration; and
assigning, by the computer processor, one or more of roles and privileges for collaboration to each participant.

65. The method of claim 64, wherein one or more documents may be shared simultaneously with the authorized one or more participants via a common online interface.

66. The method of claim 45, wherein the receiving entity is a lender entity.

67. A computer implemented system for providing construction loan administration comprising:
a computer processor;
a computer memory;
a registration module for enabling a user to register with the system for construction loan administration wherein at least one loan is identified by the user and the user is assigned a user identifier and a password and the at least one loan comprises an existing construction loan;
an invitation module for sending a message to one or more participants associated with the at least one loan to join the system for construction loan administration wherein the one or more participants are identified by the user and applying one or more of privileges and roles to each of the one or more participants, wherein the one or more privileges and roles are assigned by the user;
a loan module for processing data associated with the at least one loan via the system through an online interface; and performing one or more actions concerning the at least one loan wherein the one or more actions comprise at least submitting information to a receiving entity and submitting one or more draw requests wherein the draw requests are based on one or more stages of construction; and
a notification module for identifying one or more triggering events associated with the at least one loan; identifying one or more contacts to be notified after an occurrence of the one or more triggering events; identifying one or more preferred modes of notification for the one or more contacts after the occurrence of the one or more triggering events; and generating a notification to be sent to the one or more contacts after the occurrence of the one or more triggering events via the one or more preferred modes of notification.

68. The system of claim 67, wherein the loan module provides loan data specific for the at least one loan wherein the loan data comprises one or more of insurance data, interest data and budget summary data.

69. The system of claim 67, wherein the loan module provides collateral data associated with the at least one loan.

70. (canceled)

71. The system of claim 67, wherein the one or more draw requests comprises line item draw requests.

72. The system of claim 67, wherein the one or more draw requests comprises unit draw requests for one or more of new starts and existing units.

73. The system of claim 67, wherein the user provides one or more of insurance, interest, budget, collateral and contact information associated with each loan.

74. The system of claim 67, further comprising:
a reports module for generating one or more reports for the at least one loan based on one or more user defined specifics.

75. The system of claim 67, further comprising:
a collateral module for adding collateral data for at least one new collateral associated with the loan.

76. The system of claim 67, further comprising:
a collateral module for updating collateral data for at least one collateral associated with the loan.

77. The system of claim 76, wherein the collateral data comprises one or more of plan type, status, sales price, amount complete and remote cost data.

78. The system of claim 77, wherein the collateral module further analyzes the collateral data to determine collateral eligibility.

79. The system of claim 77, wherein the collateral module further generates a compliance worksheet for identifying one or more compliance issues associated with the at least one loan.

80. The system of claim 67, further comprising:
an import module for updating data associated with the at least one loan and importing the updated data to a receiving entity.

81. The system of claim 80, wherein the data comprises collateral data concerning one or more pieces of collateral associated with the at least one loan and wherein the receiving entity is a lender entity and the collateral data comprises one or more of plan type, status, sales price, amount complete and remote cost data.

82. The system of claim 67, further comprising:
an export module for updating data associated with the at least one loan; identifying one or more filters to be applied to the updated data; and exporting the filtered updated data from the system for construction loan administration to a remote device.

83. The system of claim 82, wherein the data comprises collateral data comprising one or more of plan type, status, sales price, amount complete and remote cost data.

84. The system of claim 82, wherein the remote device comprises one or more of a personal computer, personal digital assistant and wireless device.

85. (canceled)

86. The system of claim 67, further comprising:
a collaboration module for authorizing one or more participants for collaboration; and assigning one or more of roles and privileges for collaboration to each participant.

87. The system of claim 86, wherein one or more documents may be shared simultaneously with the authorized one or more participants via a common online interface.

88. The system of claim 67, wherein the receiving entity is a lender entity.

89.-92. (canceled)

93. An article of manufacture for construction loan administration comprising:
a computer readable storage medium; and
instructions carried on the computer readable storage medium;
wherein the instructions are configured to be readable from the computer readable storage medium by at least one processor and thereby cause the at least one processor to operate so as to:
register with a system for construction loan administration wherein at least one loan is identified and the at least one loan comprises an existing construction loan;
identify one or more participants associated with the at least one loan to join the system for construction loan administration;
assign one or more of privileges and roles to each of the one or more participants;
manage the at least one loan via the system through an online interface wherein data associated with the at least one loan is accessed and viewed according to user input, wherein the data comprises budget summary data comprising a line item budget and a disbursed amount;
perform one or more actions concerning the at least one loan wherein the one or more actions comprise at least submitting information to a receiving entity and submitting one or more draw requests wherein the draw requests are based on one or more stages of construction;
specify one or more triggering events associated with the at least one loan;
identify one or more contacts to be notified after an occurrence of the one or more triggering events;
identify one or more preferred modes of notification for the one or more contacts after the occurrence of the one or more triggering events; and
generate a notification to be sent to the one or more contacts after the occurrence of the one or more triggering events via the one or more preferred modes of notification.

94. An article of manufacture for construction loan administration comprising:
at least one processor readable storage medium; and
instructions carried on the at least one processor readable storage medium;
wherein the instructions are configured to be readable from the at least one processor readable storage medium by at least one processor and thereby cause the at least one processor to operate so as to:
allow a user to register with a system for construction loan administration wherein at least one loan is identified by the user and the user is assigned a user identifier and a password and the at least one loan comprises an existing construction loan;
send a message to one or more participants associated with the at least one loan to join the system for construction loan administration wherein the one or more participants are identified by the user;
apply one or more of privileges and roles to each of the one or more participants wherein the one or more privileges and roles are assigned by the user;
process data associated with the at least one loan via the system through an online interface;
perform one or more actions concerning the at least one loan wherein the one or more actions comprise at least submitting information to a receiving entity and submitting one or more draw requests wherein the draw requests are based on one or more stages of construction;
specify one or more triggering events associated with the at least one loan;
identify one or more contacts to be notified after an occurrence of the one or more triggering events;
identify one or more preferred modes of notification for the one or more contacts after the occurrence of the one or more triggering events; and
generate a notification to be sent to the one or more contacts after the occurrence of the one or more triggering events via the one or more preferred modes of notification.

95. A computer readable storage medium comprising computer readable program code embodied therein, said computer readable program code adapted to be executed on a processor to implement a method of construction loan administration, comprising:
registering with a system for construction loan administration wherein at least one loan is identified and the at least one loan comprises an existing construction loan;
identifying one or more participants associated with the at least one loan to join the system for construction loan administration;
assigning one or more of privileges and roles to each of the one or more participants;
managing the at least one loan via the system through an online interface wherein data associated with the at least one loan may be accessed and viewed according to user input wherein the loan data comprises budget summary data, wherein the budget summary data comprises a line item budget and a disbursed amount;
performing one or more actions concerning the at least one loan wherein the one or more actions comprise at least submitting information to a receiving entity and submitting one or more draw requests wherein the draw requests are based on one or more stages of construction;
specifying one or more triggering events associated with the at least one loan;
identifying one or more contacts to be notified after an occurrence of the one or more triggering events;
identifying one or more preferred modes of notification for the one or more contacts after the occurrence of the one or more triggering events; and
generating a notification to be sent to the one or more contacts after the occurrence of the one or more triggering events via the one or more preferred modes of notification.

96. A computer readable storage medium having computer readable program code embodied therein, said computer readable program code adapted to be executed on a processor to implement a method of construction loan administration, comprising:
enabling a user to register with a system for construction loan administration wherein at least one loan is identified by the user and the user is assigned a user identifier and a password;
sending a message to one or more participants associated with the at least one loan to join the system for construction loan administration wherein the one or more participants are identified by the user and the at least one loan comprises an existing construction loan;
applying one or more of privileges and roles to each of the one or more participants wherein the one or more privileges and roles are assigned by the user;
processing data associated with the at least one loan via the system through an online interface;
performing one or more actions concerning the at least one loan wherein the one or more actions comprise at least submitting information to a receiving entity and submitting one or more draw requests;
specifying one or more triggering events associated with the at least one loan;
identifying one or more contacts to be notified after an occurrence of the one or more triggering events;
identifying one or more preferred modes of notification for the one or more contacts after the occurrence of the one or more triggering events; and
generating a notification to be sent to the one or more contacts after the occurrence of the one or more triggering events via the one or more preferred modes of notification.

97. A computer implemented system for providing construction loan administration comprising:
a computer processor;
a computer memory;
a registration module for enabling a user to register with a system for construction loan administration, wherein at least one loan is identified and the at least one loan comprises an existing construction loan, and for creating an account for the user, wherein the user is assigned a user identifier and a password; and
a draw module for:
(a) submitting one or more draw requests against the at least one loan, wherein the draw requests comprise one or more of a line item draw, an existing residential draw, or a new unit start draw;
(b) processing the draw request; and
(c) sending a draw package request, wherein the draw package request comprises one or more of a request for invoices and lien waivers.

98. The method of claim 1, wherein the trigger event comprises one or more of the draw request, a draw approval, or an interest rate change.
